(19) United States
(12) Patent Application Publication
(10) Pub. No.: US 2004/0153355 A1
(43) Pub. Date: Aug. 5, 2004

(54) Method and system for assessing leadership skills

(76) Inventors: Anne M. Deering, London (GB); Robert Dilts, Santa Cruz, CA (US); Julian Russell, London (GB)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/356,313

(22) Filed: Jan. 31, 2003

(51) Int. Cl. G06F 17/60

(52) U.S. Cl. 705/9

(57) ABSTRACT

A method and system for an organization and/or employer to evaluate the leadership skills of individuals and/or employees, and to compare the leadership skills of individuals to average leadership skills for the employer's organization and/or industry. Individual personality and behavioral data from the employer and/or other sources are evaluated to determine two scores, one rating management skills and the other rating experience level. A graph comparing each individual to baseline management skill averages for the organization and/or the relevant industry, to baseline experience level averages for the organization and/or the relevant industry, and to a best fit line generated from multiple individual personality and behavioral data is generated. Individuals can then be grouped into categories based on combinations of high and low management skills and high and low experience level. The category within which an individual falls reflects the individual's assessed leadership qualities.

### BACKGROUND OF THE INVENTION

The present invention is generally directed to a new method and system for assessing leadership skills of individuals, especially managers.

Effective leadership is most important in organizations. Venture capitalists have always recognized this—they do not fund good ideas, they fund good leaders.

In today's business environment, leadership is in crisis. The current shortage of business leaders is expected to worsen. According to industry sources there will be a 15% decline in 35-44 year old business leaders (the most experienced) in the next decade, and new leaders churn with far more frequency than earlier management generations. Recent studies identify this trend toward increased executive turnover—revealing that executives will work for an average of seven different employers in the course of a typical executive career, an increase from an average of three just two decades ago. High turnover rates cost companies millions of dollars in increased recruitment costs as well as in lost knowledge and development assets.

Studies also indicate that the majority of business leaders are generally unhappy with their current lifestyle. 70% of managers want to spend more time with family, and 30% report that their lives are “out of control.”

The foregoing presents an increasingly serious problem in today's business environment. In this context, organizations need a way of rapidly and effectively assessing management strengths and development needs, with a view to retaining the best talent, building leadership strengths and depth, and assessing management fit in key positions. This assessment should be based on the skills leaders require to be successful in a technology, knowledge and relationship driven economy.

### SUMMARY OF THE INVENTION

Generally speaking, the present invention provides a method and system for assessing the leadership skills of individuals that satisfies the above-noted needs of organizations.

The preferred method according to the present invention involves obtaining (e.g., during an interview) data representing both the experience (e.g., tenure in job, organization and industry) and certain behavioral and personality traits (e.g., ability to anticipate, to be aligned and to act) of an individual being assessed. The experience data is statistically reduced to yield an experience profile score. The behavioral and personality data is statistically reduced to yield a skills profile score.

Benchmark data representing the experience profile scores and skills profile scores for a preselected set of individuals are calculated. For each individual assessed, the individual's experience profile score and skills profile score are compared against the benchmark data. Based on such comparison, the individual assessed can be categorized as to leadership ability—that is, as one of a developing leader, strong leader, unproven leader and poor leader. The leadership assessment can be reported, including in a graphical format. Recommendations, including how to utilize, if at all, and/or further develop the individual's leadership skills, can then be made based on the report.

The preferred system according to the present invention provides means for effecting the foregoing preferred method steps.

Other aspects and advantages of the present invention will in part be obvious and will in part be apparent from the specification.

The present invention accordingly comprises the various steps and the relation of one or more of such steps with respect to each of the others, and the system embodies features of construction, combinations of elements, and arrangement of parts which are adapted to effect such steps, all as exemplified in the following detailed disclosure, and the scope of the invention will be indicated in the claims.

### BRIEF DESCRIPTION OF THE DRAWINGS

For a fuller understanding of the invention, reference is had to the following description taken in connection with the accompanying drawings in which:

FIG. 1 is a schematic diagram depicting a system constructed and arranged in accordance with a preferred embodiment of the present invention;

FIG. 2 is a schematic diagram depicting the use of software in the system depicted in FIG. 1;

FIG. 3 is a high-level process flow depicting collection, entry, analysis and display of data in accordance with a preferred embodiment of the method and system of the present invention;

FIGS. 4A and 4B are flow diagrams illustrating how an individual's skills profile score and experience profile score are determined in accordance with a preferred embodiment of the method and system of the present invention;

FIGS. 5A-5S depict representative data sheets used in the management assessment data collection process according to a preferred embodiment of the method and system of the present invention;

FIG. 6A is a high level flow diagram depicting the process by which management assessment data are input, analyzed, and displayed in accordance with a preferred embodiment of the method and system of the present invention;

FIG. 6B is a flow diagram depicting the process by which management assessment data are input and analyzed in accordance with a preferred embodiment of the method and system of the present invention;

FIG. 6C is a flow diagram illustrating the process by which skills and experience data are analyzed to generate an assessment of an individual's leadership qualities in accordance with a preferred embodiment of the method and system of the present invention; and

FIG. 7 depicts a graphical output representing a management assessment in accordance with the method and system of the present invention.

### DETAILED DESCRIPTION OF THE INVENTION

The present invention is directed to a method and system for evaluating the leadership skills of individuals, particularly managers. Data on the personality, behavioral traits and experience of an individual can be obtained, input, stored, analyzed and displayed via a network accessible database to yield an assessment of such individual's leadership skills. Such assessment can be used by an organization, for example, as a basis for making recommendations for organization and individual management development; identifying issues arising from internal human resource availability; making recommendations regarding organization development, recruiting and career management of individuals; and providing constructive feedback to the individual evaluated.

The method and system according to the present invention can be implemented using a related combination of automated interfaces and manual processes. It should be appreciated, however, that greater use of automated processing and a wider range of features with multiple executions and data comparisons is also contemplated by the present invention.

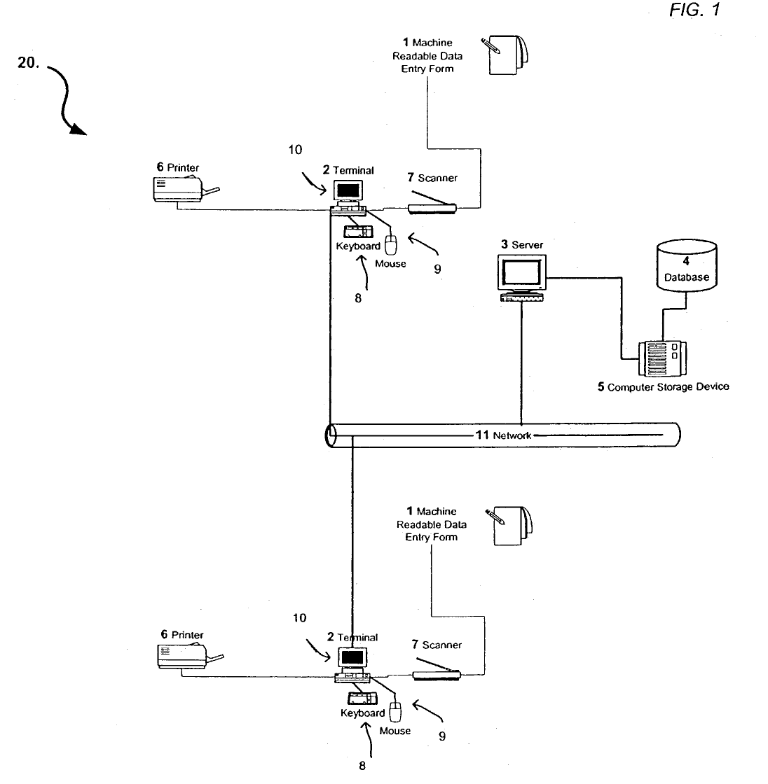

FIG. 1 depicts a simplified schematic illustration of a preferred system, shown generally at 20, and including the component assets and means necessary to effect and control the various process steps according to the present invention as described hereinafter. Desirably, and where appropriate, the system utilizes existing computer capabilities, both hardware and software, and electronic communications links, to, for example, receive and process, in real time, an individual's raw data and display comparisons of individuals to database and organization specific skill and experience scores, as described in detail hereinafter.

System 20 preferably includes a computer server 3 having electronic access to a computer storage means 4, which may be a database or spreadsheet or the like, residing on a physical storage device 5. Server 3 operates under control of computer software to carry out the inventive process steps described in greater detail hereinafter.

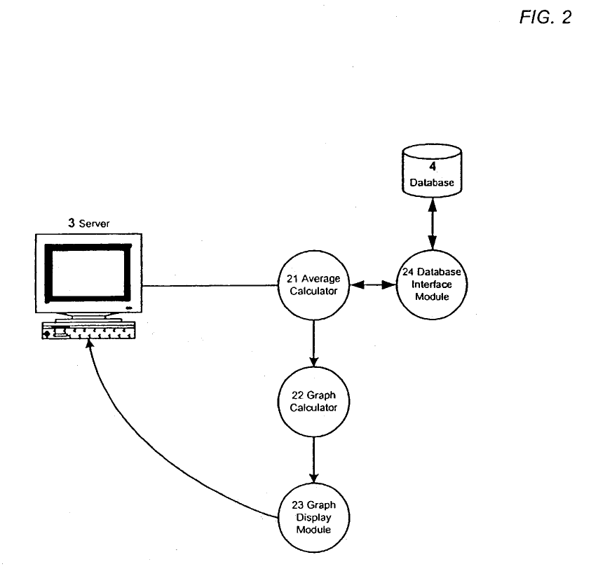

As depicted in FIG. 2 and as described in greater detail hereinafter, the computer software preferably includes an average calculator 21, a graph calculator 22, a graph display module 23, and a database interface module 24, each a set of software objects and/or program elements collectively having the ability to execute independently in a separate thread or as a logical chain of process execution, while permitting the flow of data inputs therebetween. Average calculator 21, graph calculator 22, graph display module 23, and database interface module 24, can each be executed as a separate logical server or using a separate physical device. However, server 3 desirably operates as a single logical server.

Referring again to FIG. 1, server 3 is electronically coupled to a network 11, and computer storage device 5. Server 3 is in communication with at least one user interface 2 having conventional input devices, such as a keyboard 8 and a mouse 9, a conventional display device 10, and a conventional hardcopy output device 6, e.g., a laser printer. User interface 2 is desirably connected to a data input device 7 capable of automated paper form reading. Data input device 7 is preferably a scanner reader or other automated paper form reading device.

User interface 2 is preferably a remote interface, e.g., a personal computer, coupled to server 3 via a privately accessible global computer network. A common example of such a network is the Internet. It should be understood that data can be provided for analysis and storage either via Internet transmission or email, portable computer storage device or diskette, or by direct entry.

Although not indicated in the drawings, it should be understood that system 20 can also be operated without data input device 7. Data can instead be manually entered via conventional input devices 8 and 9.

It should also be understood that system 20 may be implemented by other known methods of computer networking and that the arrangement of component devices is not restricted to that which is described herein. It should be further understood that system 20 can be composed of alternative devices having similar functions to the component devices described herein.

Users of system 20 can include organizations, businesses, human resource outsourcing companies, business consultants, efficiency consultants, and others involved in assessing quality and/or skill levels of management personnel.

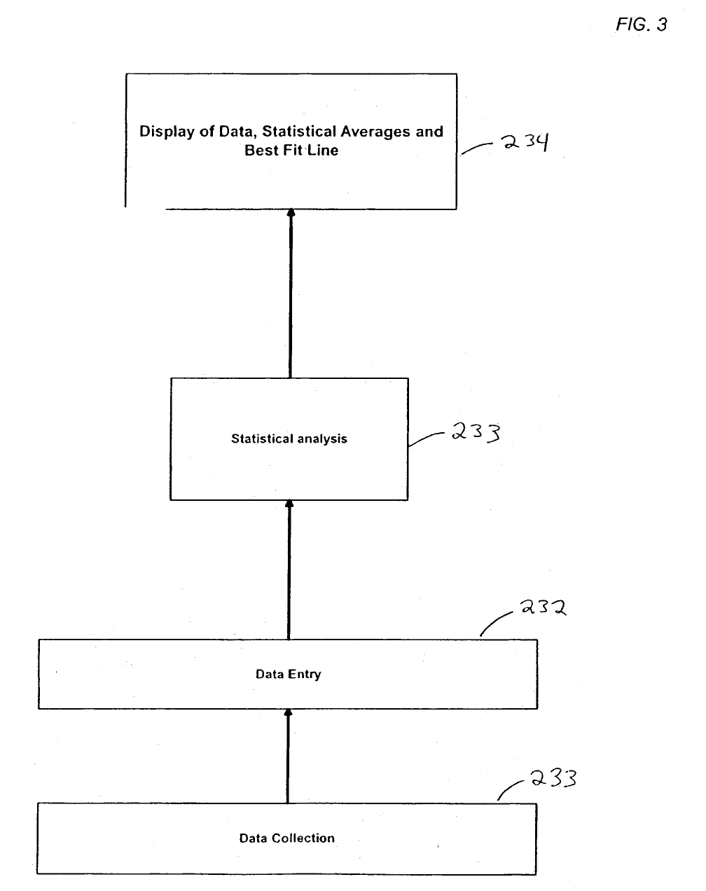

Broadly speaking, system 20 performs four functions: (i) management assessment data collection, (ii) management assessment data entry, (iii) statistical analysis and comparison of management assessment data, and (iv) analyzed management assessment data display. Referring now to FIG. 3, management assessment data collection involves the scoring of an individual's leadership skills and experience via a series of behavioral statements, desirably elicited by an interview of the individual (step 231). The management assessment data entry function of system 20 involves manually or automatically entering management assessment data obtained in function (i) (step 232). Statistical analysis of management assessment data involves the averaging of management assessment data to generate a skills profile score and an experience profile score (step 233). The function of analyzed management assessment data display involves the graphical display of an individual's skills and experience profile scores in relation to average profile scores and a best fit line (step 234). The functions of management assessment data collection and entry and the statistical analysis, comparison and display of management assessment data are described in greater detail hereinafter.

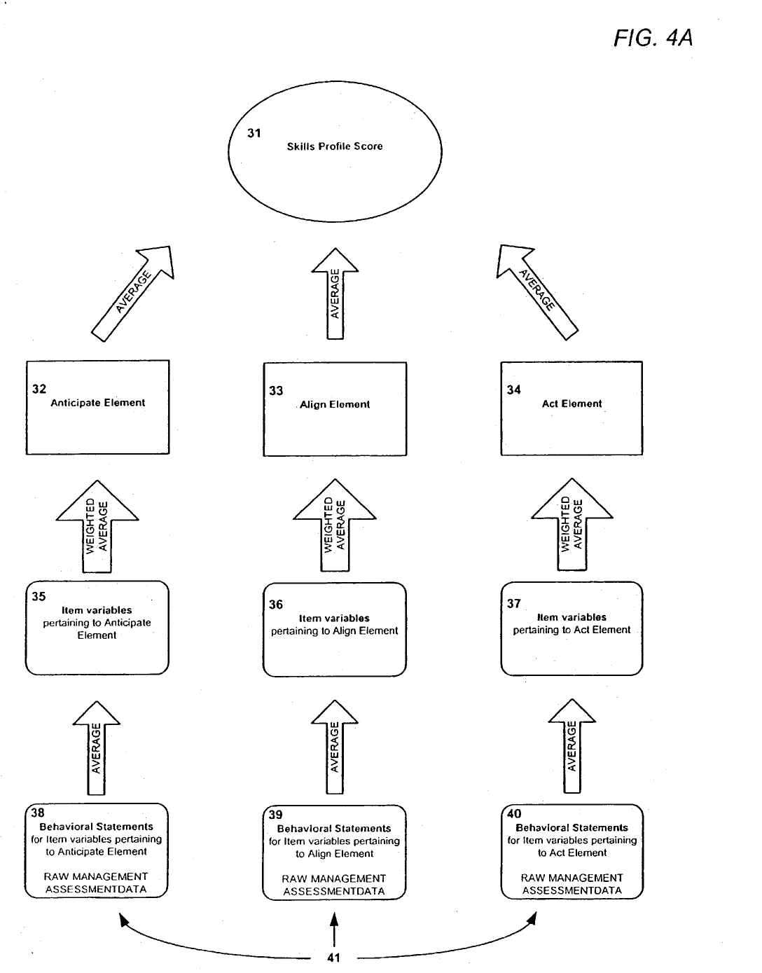

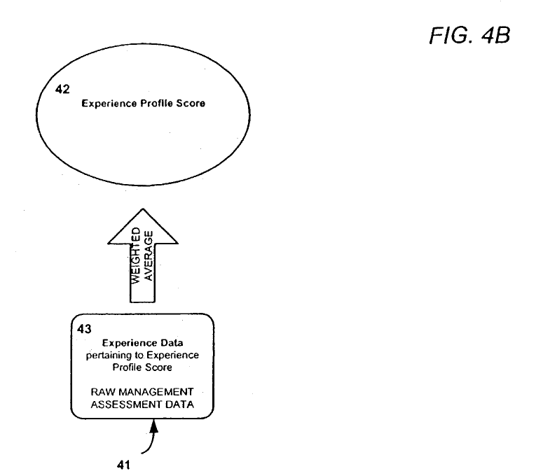

FIGS. 4-9, illustrate in greater detail a preferred embodiment of the present invention whereby collection, entry, statistical analysis and display of management assessment data are effected.

Referring to FIG. 4A, a skills profile score 31 is calculated from collected raw management assessment data 41. Skills profile score 31 represents management and leadership skills and traits and preferably comprises the average of three element variables: Anticipate 32, Align 33 and Act 34 which are more fully described below. Desirably, the three element variables 32, 33 and 34 respectively comprise the weighted averages of three sets of one or more item variables 35, 36 and 37 associated with groupings of behavioral statements 38, 39 and 40 relating to personality and behavioral traits. Preferably, each item variable comprises one or more behavioral statements which are scored on a preselected numeric scale. Varying or equal weights may be assigned to any of the element variables, item variables or behavioral statements. From the foregoing, for clarity, it should be appreciated that the term behavioral statement as used herein refers to raw management assessment data 41 relating to personality and behavioral traits used to calculate skills profile score 31 in accordance with the method and system of the present invention.

Referring to FIG. 4B, an experience profile score 42 is also calculated from collected raw management assessment data 41. Experience profile score 42 represents the tenure of an individual in their role (e.g. position), organization, and industry and preferably comprises three numerically scored experience data variables 43: time in role, time in organization and time in industry, which are more fully described below. A weighted average is taken from experience data variables 43 to calculate experience profile score 42. Varying or equal weights can be assigned to any of the experience data variables. It should be appreciated that the term experience data variable refers to raw management assessment data 41 relating to experience used to calculate the experience profile score 42 in accordance with the method and system of the present invention.

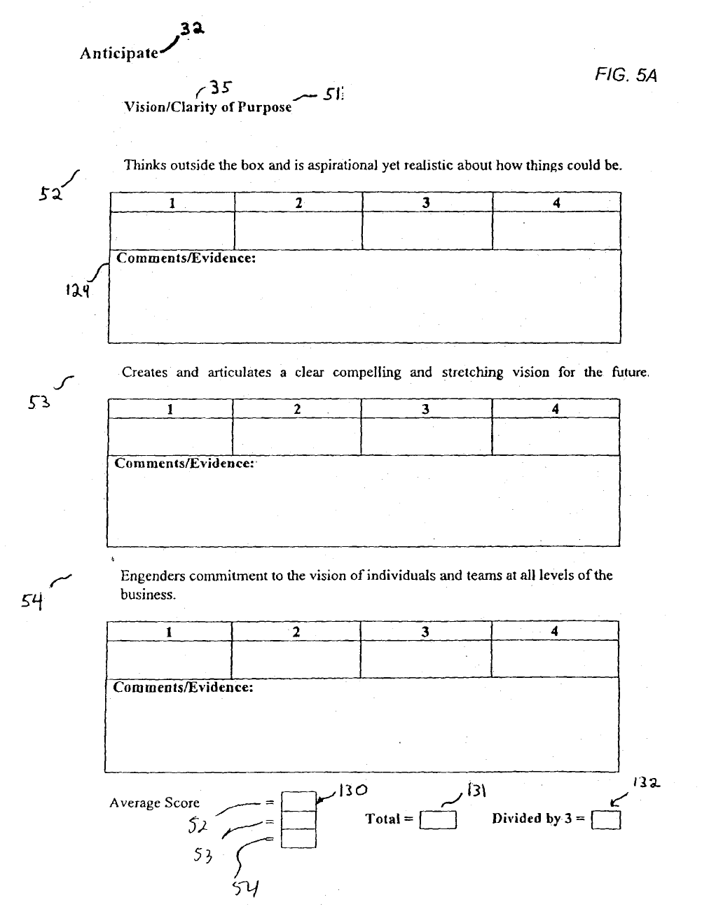

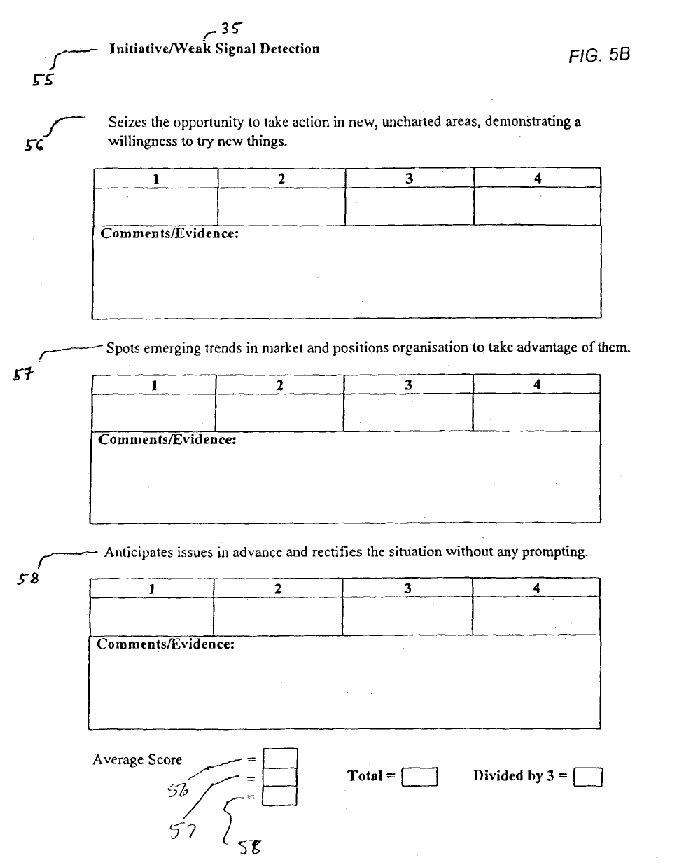

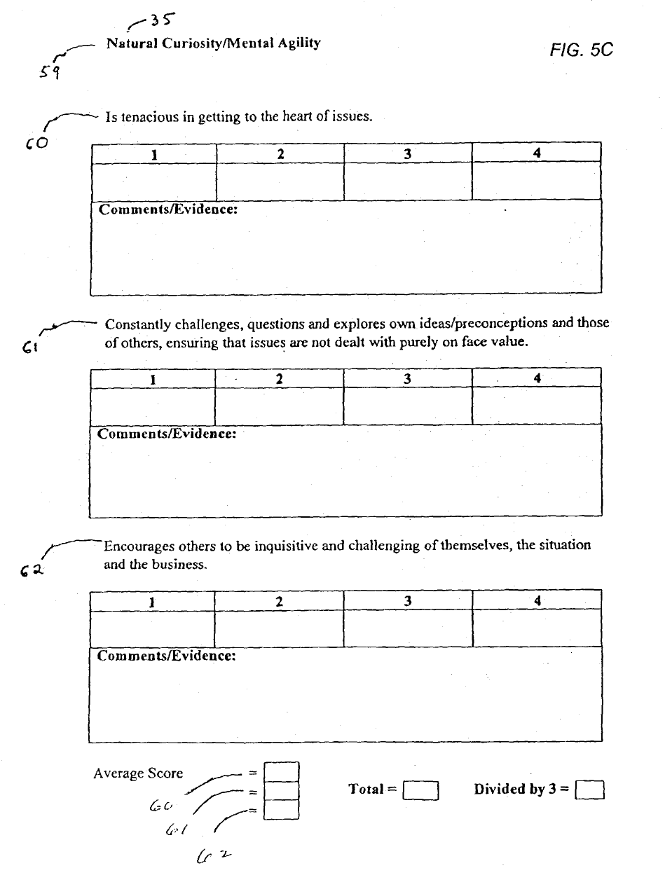

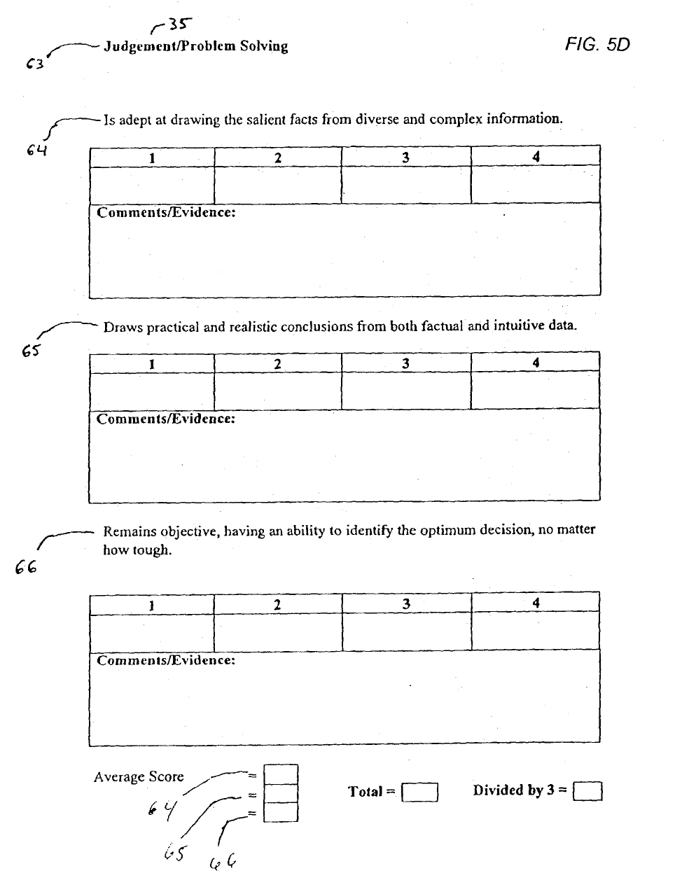

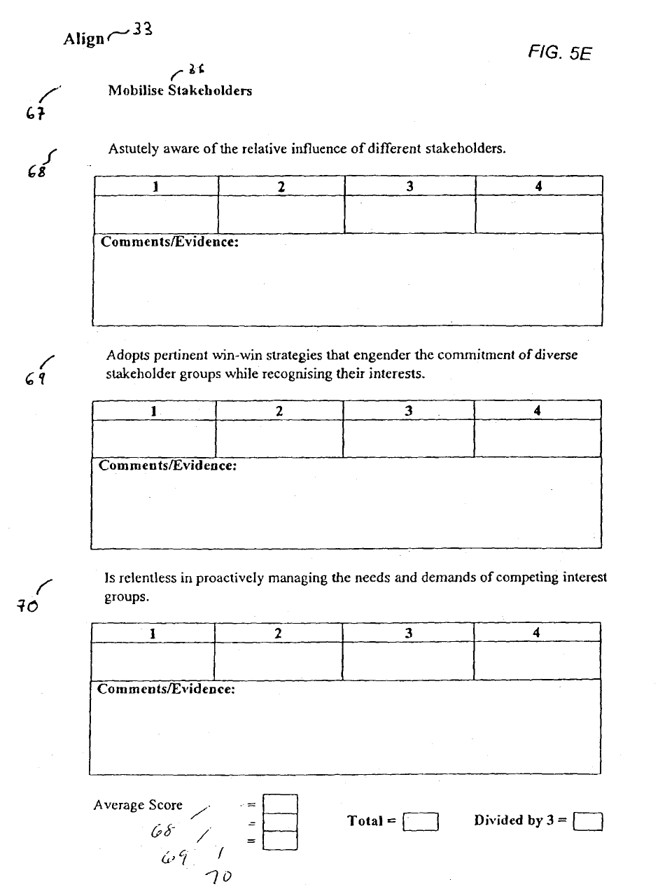

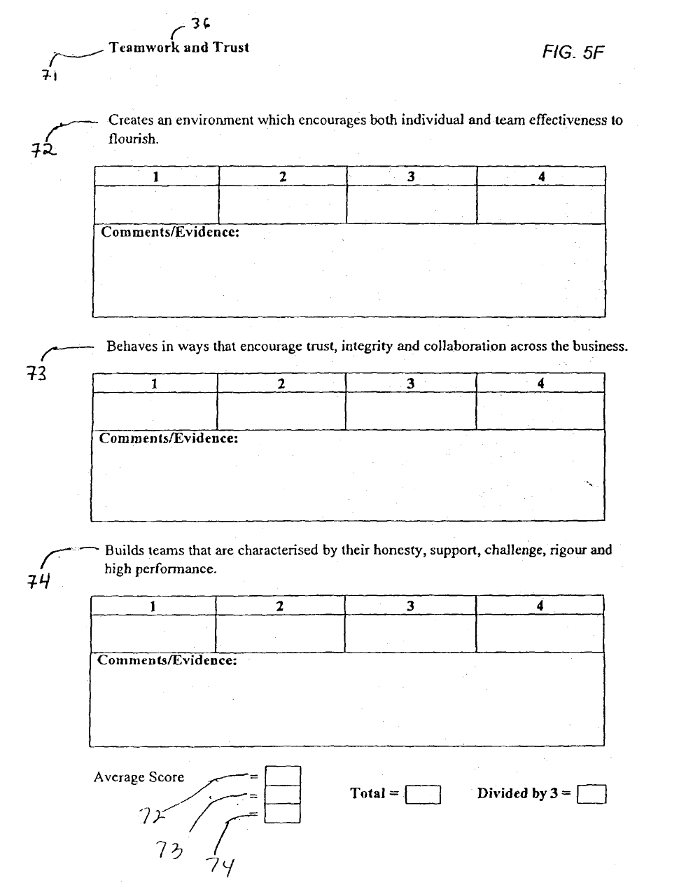

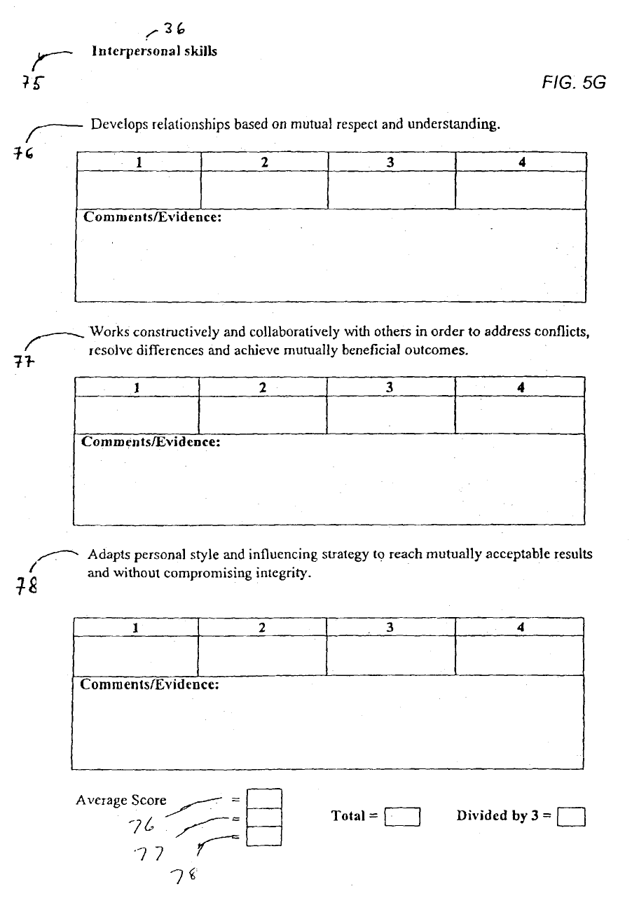

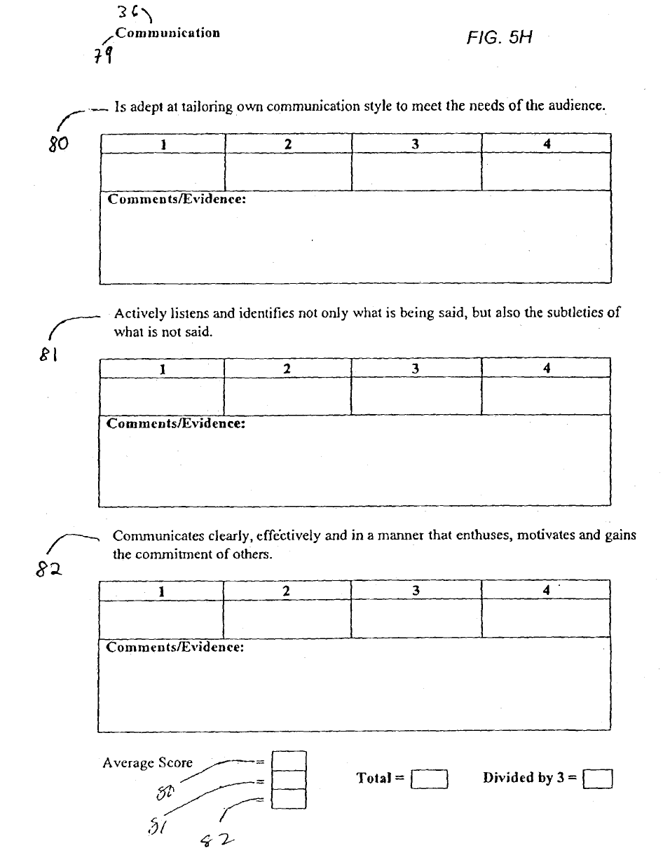

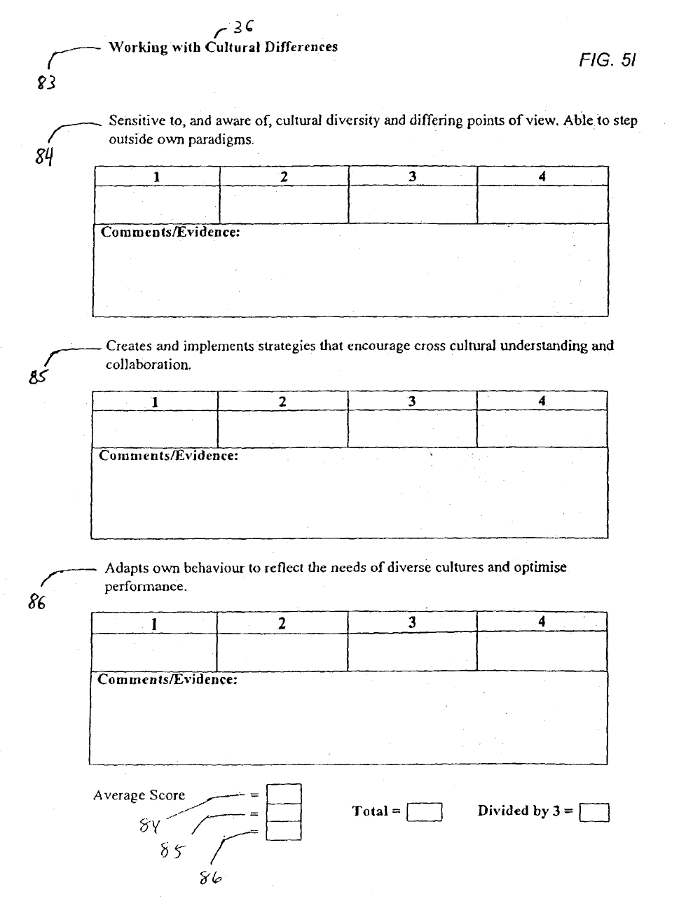

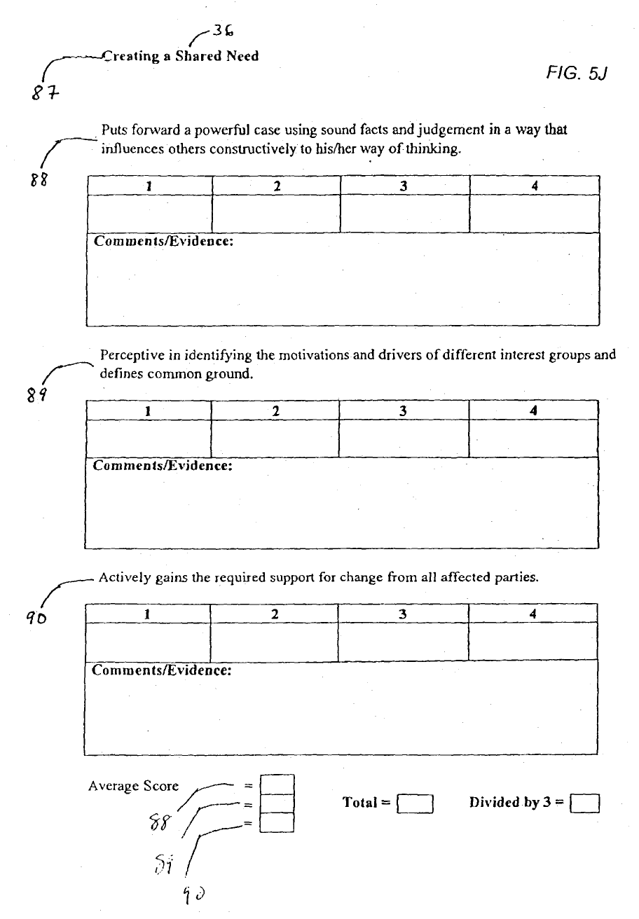

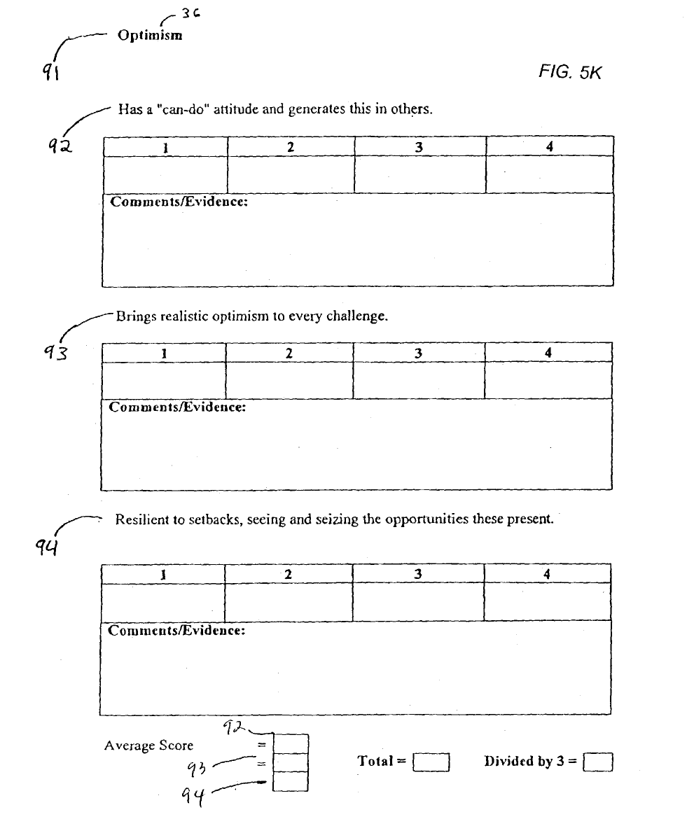

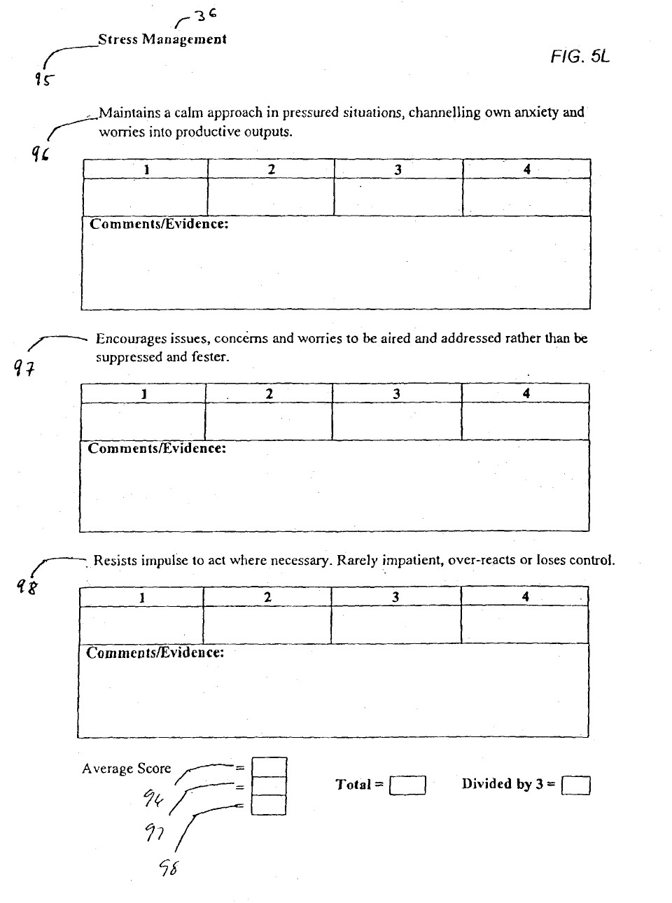

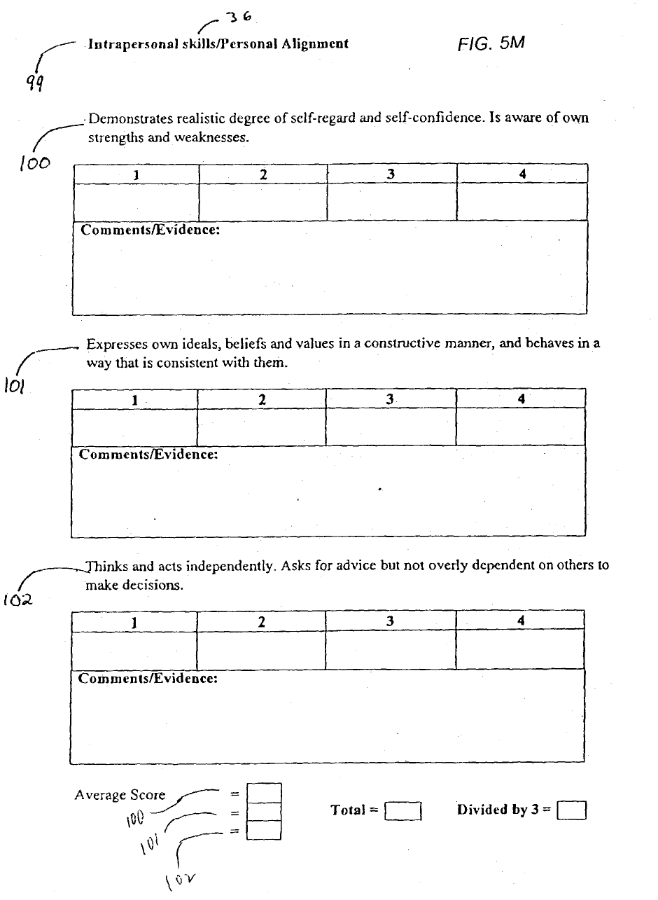

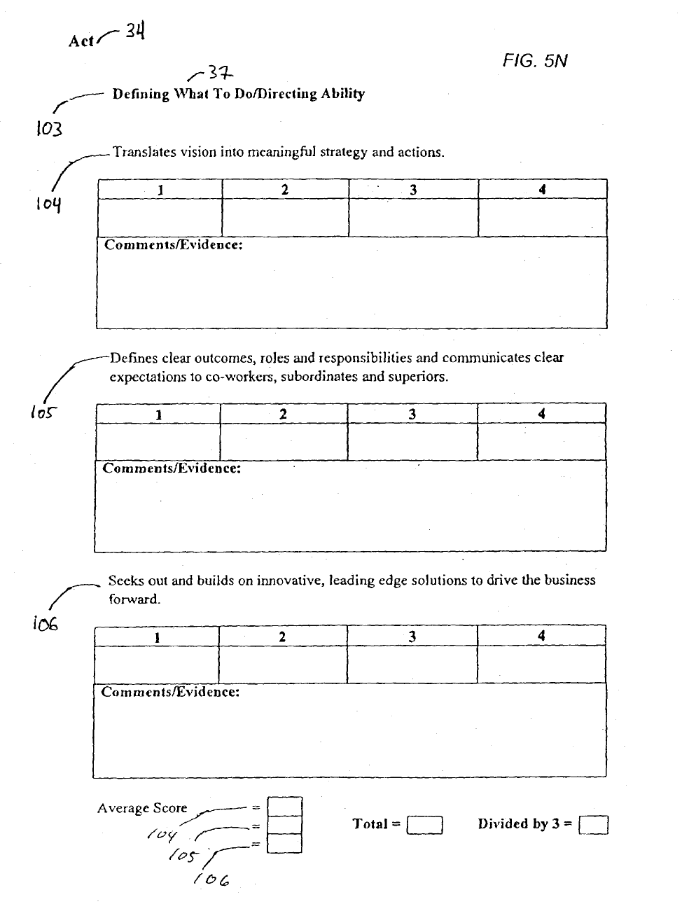

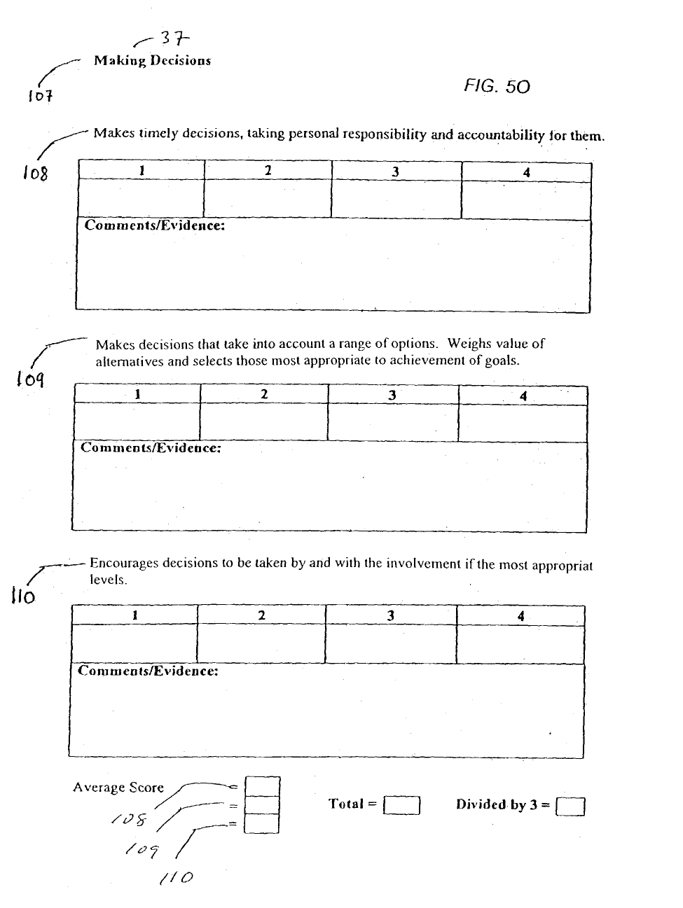

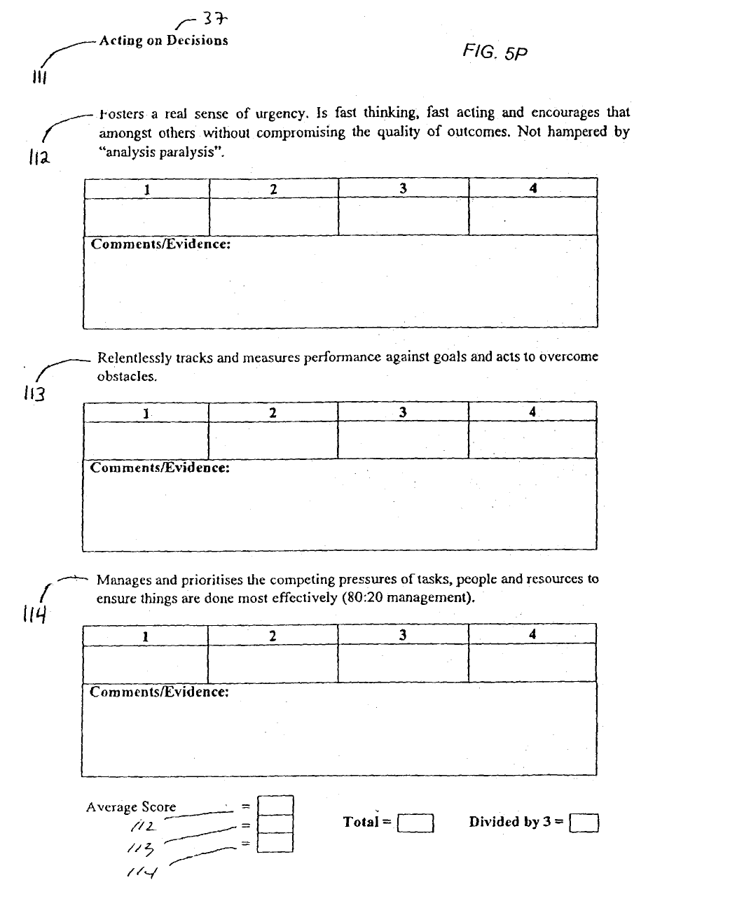

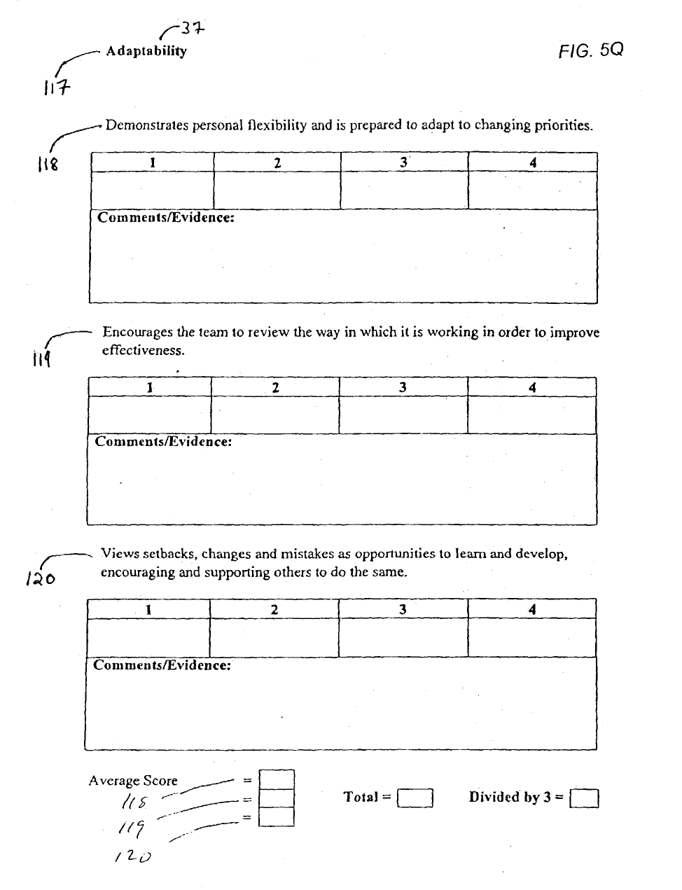

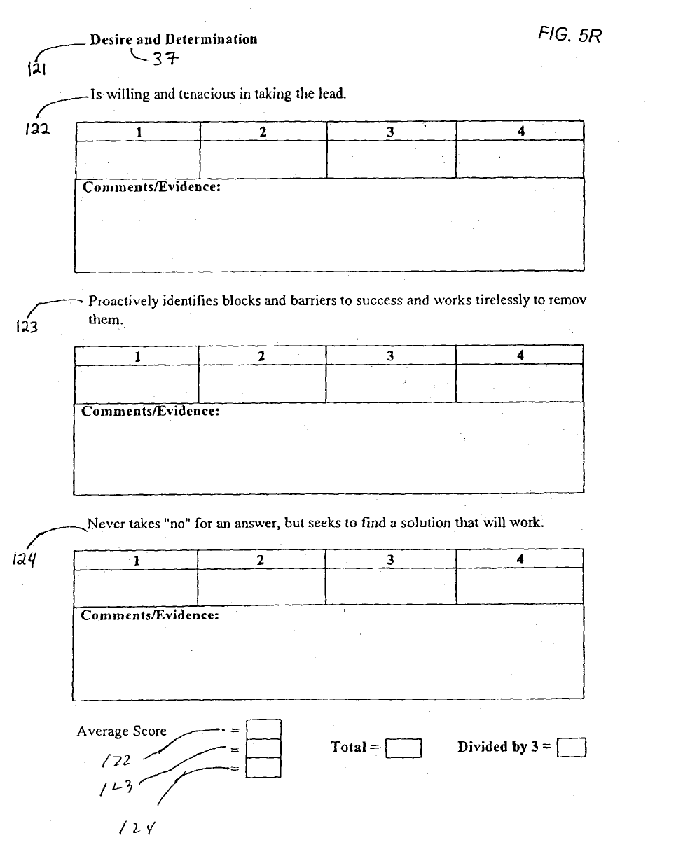

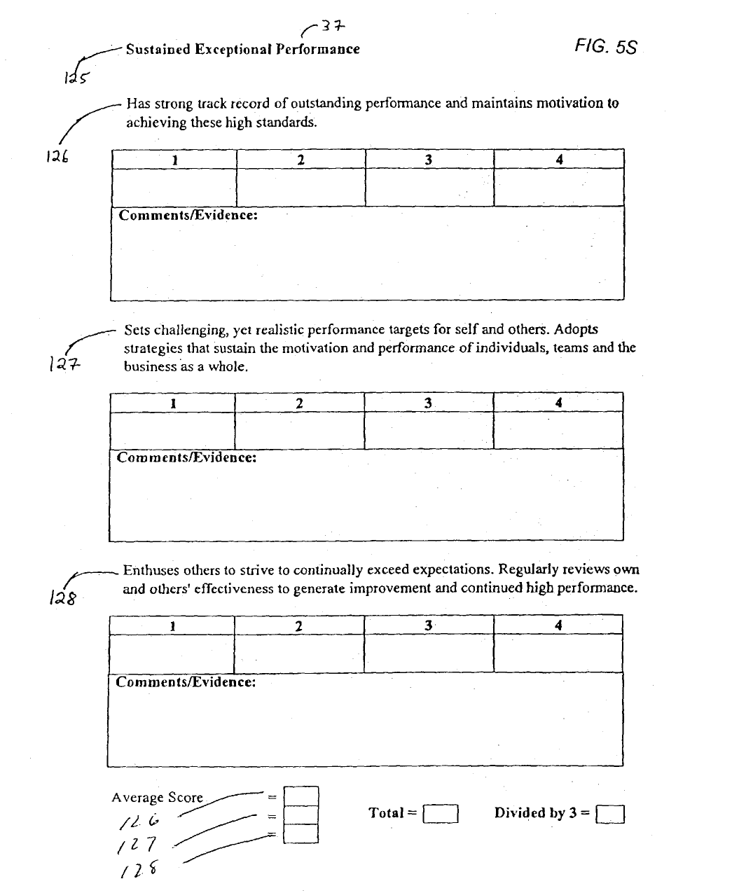

FIGS. 5A-5S, represent a preferred interview guide for collecting raw management assessment data related to the Anticipate, Align and Act element variables (32, 33, 34). Each related item variable 35, 36, 37 preferably comprises three numerically scored behavioral statements relevant to the subject matter of the item variable. Preferably, for each item variable 35, 36, 37 the interview guide utilizes a manual scoring box 129 (FIG. 5A) as an aid to filling out a machine readable data entry form 1 as depicted in FIG. 1. Referring to FIG. 5A, manual scoring box 129, a manual tabulation box 130, a total box 131 and an item variable average box 132 can be used either as a back-up paper record or, alternatively, if management assessment data are input manually.

Anticipate element variable 32 preferably measures an individual's ability to “get ahead of the curve.” Since the future is largely unpredictable, anticipation is not prediction, but rather refers to expectations. Leaders who can anticipate have the ability to detect important trends early, spot opportunities and threats embedded in such trends, and timely seize the opportunities and evade the threats.

Align element variable 33 preferably measures three core principles which are useful indicators for leadership in an organizational context: personal alignment, choice of work content and the interplay of expertise and learning, and the ability to see the world through someone else's eyes.

Act element variable 34 preferably measures the ability to prioritize tasks and focus on where the most value can be added as a step towards eliminating stress and overload, the ability to be open to and apply in-course corrections (adjustments) in attaining goals, and the ability to recognize when it is appropriate to stop a course of action towards a particular goal and redirect resources towards other more productive goals (“fish or cut bait”). These are all essential leadership abilities.

Anticipation element variable 32 involves detecting weak signals, i.e. detecting signals early before they become clear. In order to detect weak signals, leaders and their organizations must keep tabs on competitors, customers and emerging technologies, for example. Anything a customer or competitor does could be a signal that demands swift response, and emerging technologies can presage new markets and new commercial opportunities. Leaders and their organizations must gather and process the widest possible range of information because a leader will never know from where the next opportunity or threat will come, or what form it will take.

A difficulty with detecting weak signals is that they can be obscured by local noise. Local noise is composed of the assumptions and mental models that become embedded in the cognitive processes with which organizations filter and make sense of the information they receive. Effective leaders must be adept at filtering such noise. The ability to detect weak signals is therefore a quality that the present invention aims at assessing in individuals.

Referring to FIG. 5B, a preferred series of behavioral statements is provided whereby an individual's initiative/weak signal detection ability 55, is desirably evaluated by rating the individual on a numerical scale of 1 to 4 based on behavioral statements evaluated during an interview. In the interview, an interviewer asks preselected questions of an individual to elicit responses indicative of the individual's ability to seize the opportunity to take action in new uncharted areas, demonstrating a willingness to try new things (behavioral statement 56); to spot emerging market trends and position an organization to take advantage of them (behavioral statement 57); and to anticipate issues in advance and rectify a situation without any prompting from others (behavioral statement 58).

It should be appreciated that the interview questions used in accordance with the method and system of the present invention to flush out leadership qualities in an individual related to weak signal detection or any other qualities as discussed herein can be based on the wealth of information concerning psychological attributes of leadership available to those of ordinary skill in the art.

Anticipation also requires mental agility. For leaders to be mentally agile, they need the ability to explore beyond their boundaries, recognize the limits within which creativity operates successfully, and be flexible in pursuit of goals despite encountering obstacles to their achievement. These are therefore also qualities that the present invention aims at assessing in individuals.

Vision or clarity of purpose is an essential component of mental agility. Referring to FIG. 5A, a preferred series of behavioral statements is provided whereby an individual's vision/clarity of purpose ability 51 is desirably evaluated by rating the individual on a numerical scale of 1 to 4 based on behavioral statements evaluated during the interview. In the interview, preselected questions are asked of an individual to elicit responses indicative of the individual's ability to think “outside the box” while being aspirational and realistic (behavioral statement 52); to create and articulate a clear, compelling, stretching vision for the future (behavioral statement 53); and to engender commitment to the vision of individuals and teams at all organizational levels (behavioral statement 54).

Curiosity is another essential component of mental agility. Referring to FIG. 5C, a preferred series of behavioral statements is provided whereby an individual's natural curiosity/mental agility ability 59 is desirably evaluated by rating the individual on a numerical scale of 1 to 4 based on behavioral statements evaluated during the interview. In the interview, preselected questions are asked of an individual to elicit responses indicative of the individual's tenaciousness in getting to the heart of issues (behavioral statement 60); ability to constantly challenge, question and explore their own ideas/preconceptions and those of others, ensuring that issues are not dealt with purely on face value (behavioral statement 61); and ability to encourage others to be inquisitive and challenging of themselves, the situation and the business (behavioral statement 62).

Referring to FIG. 5D, another essential component of mental agility, an individual's judgment/problem solving ability 63, is desirably evaluated by rating the individual on a numerical scale of 1 to 4 based on behavioral statements evaluated during the interview. In the interview, preselected questions are asked of an individual to elicit responses indicative of the individual's ability to be adept at drawing salient facts from diverse and complex information (behavioral statement 64); to draw practical and realistic conclusions from both factual and intuitive data (behavioral statement 65); and to remain objective, having an ability to identify the optimum decision, no matter how tough (behavioral statement 66).

Thus, Anticipate element variable 32 preferably comprises four item variables 35 rating an individual's capacity to have initiative/weak signal detection 55, vision clarity of purpose 51, natural curiosity/mental agility 59, and judgment/problem solving 63 (FIGS. 5A-5D).

Turning now to Align element 33, three core principles emerge which are useful indicators that can be applied in learning how to lead in an organizational context: personal alignment, choice of work content and the interplay of expertise and learning, and the ability to see the world through someone else's eyes. These are qualities assessed by the present invention.

Personal alignment is an alignment between what one believes and how one acts. A leader's internal congruence or alignment is a powerful agent in moving people from words to action. Leaders who know who they are, know their ‘calling’ and walk their talk, will be trusted and will attract motivated followers.

Personal alignment, called by a variety of names including “self-confidence,” “personal presence,” “gravitas” and “charisma,” is a behavioral manifestation of deep internal processes. Although behavioral training can increase presence, any lack of authenticity or sincerity can be readily detected.

A compilation of “logical levels” can be a useful way of exploring the dimensions on which one can attain personal alignment:

1. what I am a part of—context, self-transcendence, spirit;

2. who I am—identity;

3. what I believe—beliefs, values, motivations;

4. what I am capable of—skills, competencies, ambition;

5. what I do—behavior, actions; and

6. the environment—external surroundings.

Effective leaders tend to be fully aligned on every level. Unfortunately, it is easy to get out of alignment on any one of these levels, and, as a result, experience stress, anxiety and a feeling that efforts lack meaning. These incongruities can be ignored, often for many years, but they will eventually take their toll on motivation, energy, and even health.

Aligned leaders generally have a sense of something greater than themselves or their organization. Aligned leaders also have a high degree of self awareness and self acceptance, yet are motivated to achieve more and improve their skills. Effective leaders harness the discretionary energy of people, getting them to do things because they want to rather than because they have to, therefore aligned leaders tend to be more aware of their values and beliefs, and make efforts to reflect these in their behavior, thus inspiring trust in those who work with them. Aligned leaders have a unique sense of mission and have the ability to develop and implement their vision and strategy; the ability to influence and manage relationships; the ability to coach and delegate appropriately; and the ability to prioritize. Aligned leaders take care to ensure that how they act matches what they say, and use the visibility of their behavior to transmit messages to their superiors, peers, subordinates and other “stakeholders.” Aligned leaders deliberately design work environments to promote their values and priorities.

Referring to FIGS. 5E-5M, Align element variable 33 preferably comprises nine item variables 36 rating an individual's capacity to mobilize stakeholders 67, create teamwork and trust 71, relate to others interpersonally 75, communicate 79, work with cultural differences 83, create a shared need 87, be optimistic 91, manage stress 95, and be personally aligned and use intrapersonal skills 99.

Desirably, a leader should be able to mobilize stakeholders. This is done by building the energy and commitment of interested, involved and influential parties in order to deliver organizational objectives. Referring to FIG. 5E, an individual's ability to mobilize stakeholders 67 is desirably evaluated by rating the individual on a numerical scale of 1 to 4 based on behavioral statements evaluated during the interview. In the interview, preselected questions are asked of an individual to elicit responses indicative of the individual's ability to recognize the relative influence of different stakeholders (behavioral statement 68); to adopt pertinent win-win strategies that engender the commitment of diverse stakeholder groups while recognizing their interests (behavioral statement 69); and to be relentless in proactively managing the needs and demands of competing interest groups (behavioral statement 70).

Desirably a leader should have the ability to create teamwork and trust by creating an environment in which people work effectively together to deliver common goals and enjoy open and trusting relationships. Referring to FIG. 5F, an individual's ability to create teamwork and trust 71, is desirably evaluated by rating the individual on a numerical scale of 1 to 4 based on behavioral statements evaluated during the interview. In the interview, preselected questions are asked of an individual to elicit responses indicative of the individual's ability to create an environment which encourages both individual and team effectiveness to flourish (behavioral statement 71); to behave in ways that encourage trust, integrity and collaboration across the organization (behavioral statement 72); and to build teams that are characterized by their honesty, support, challenge, rigor and high performance (behavioral statement 73).

Desirably, a leader should have good interpersonal skills preferably in the form of communication and relationship skills that allow the leader to work well with other people, creating a good impression and encouraging collaboration. Referring to FIG. 5G, an individual's ability regarding interpersonal skills 75, is desirably evaluated by rating the individual on a numerical scale of 1 to 4 based on behavioral statements evaluated during the interview. In the interview, preselected questions are asked of an individual to elicit responses indicative of the individual's ability to develop relationships based on mutual respect and understanding (behavioral statement 76); to work constructively and collaboratively with others in order to address conflicts, resolve differences and achieve mutually beneficial outcomes (behavioral statement 77); and to adapt personal style and influence strategy to reach mutually acceptable results without compromising integrity (behavioral statement 78).

It is also desirable that a leader have the ability to communicate effectively. Effective communication is the ability to share one's own ideas and intentions with others and to receive the ideas and intentions of others and respond appropriately. Referring to FIG. 5H, an individual's ability to communicate 79, is desirably evaluated by rating the individual on a numerical scale of 1 to 4 based on behavioral statements evaluated during the interview. In the interview, preselected questions are asked of an individual to elicit responses indicative of the individual's ability to tailor their own communication style to meet the needs of the audience (behavioral statement 80); to actively listen and identify not only what is being said, but also the subtleties of what is not said (behavioral statement 81); and to communicate clearly, effectively and in a manner that enthuses, motivates and gains the commitment of others (behavioral statement 82).

Leaders should have the ability to work with cultural differences. This means the ability to operate effectively with people from other nationalities or organizational backgrounds in order to deliver organizational results. Referring to FIG. 51, an individual's ability to work with cultural differences 83, is desirably evaluated by rating the individual on a numerical scale of 1 to 4 based on behavioral statements evaluated during the interview. In the interview, preselected questions are asked of an individual to elicit responses indicative of the individual's ability to be sensitive to, and aware of, cultural diversity and differing points of view and be able to step outside their own paradigms (behavioral statement 84); to create and implement strategies that encourage cross cultural understanding and collaboration (behavioral statement 85); and to adapt their behavior to reflect the needs of diverse cultures and optimize performance (behavioral statement 86).

Leaders should be able to create a shared need, preferably by expressing the need for change or the delivery of an organizational objective in a way that other involved parties can understand and support. Referring to FIG. 5J, an individual's ability to create a shared need 87, is desirably evaluated by rating the individual on a numerical scale of 1 to 4 based on behavioral statements evaluated during the interview. In the interview, preselected questions are asked of an individual to elicit responses indicative of the individual's ability to put forward a powerful case using sound facts and judgment in a way that influences others constructively to his/her way of thinking (behavioral statement 88); to be perceptive in identifying the motivations and drivers of different interest groups and define common ground (behavioral statement 89); and to actively gain the required support for change from all affected parties (behavioral statement 90).

A leader should be optimistic, preferably by having a tendency to maintain a positive outlook and a belief in opportunity and possibility, even in the context of adverse circumstances. Referring to FIG. 5K, an individual's ability to be optimistic 91 is desirably evaluated by rating the individual on a numerical scale of 1 to 4 based on behavioral statements evaluated during the interview. In the interview, preselected questions are asked of an individual to elicit responses indicative of the individual's ability to have a “can-do” attitude and generate this in others (behavioral statement 92); and to bring realistic optimism to every challenge (behavioral statement 93); and to be resilient to setbacks and see and seize the opportunities these present (behavioral statement 94).

A leader should also be able to manage stress, preferably by recognizing and appropriately dealing with their own feelings of stress and those of other people, without letting stress impact performance. Referring to FIG. 5L, an individual's ability to manage stress 95 is desirably evaluated by rating the individual on a numerical scale of 1 to 4 based on behavioral statements evaluated during the interview. In the interview, preselected questions are asked of an individual to elicit responses indicative of the individual's ability to maintain a calm approach in pressure situations, channeling their own anxiety and worries into productive outputs (behavioral statement 96); and to encourage issues, concerns and worries to be aired and addressed rather than be suppressed and fester (behavioral statement 97); to resist impulse to act where necessary and rarely be impatient, over-react or lose control (behavioral statement 98).

A leader should have intrapersonal skills and personal alignment. Intrapersonal skills and personal alignment are those skills that enable an individual to mange themselves effectively and appropriately, with a realistic view of themselves and their performance, and congruence in how they act and what they believe and value. Referring to FIG. 5M, an individual's intrapersonal skills and personal alignment 99 is desirably evaluated by rating the individual on a numerical scale of 1 to 4 based on behavioral statements evaluated during the interview. In the interview, preselected questions are asked of an individual to elicit responses indicative of the individual's ability to demonstrate a realistic degree of self-regard and self confidence and be aware of their own strengths and weaknesses (behavioral statement 100); to express own ideals, beliefs and values in a constructive manner, and behave in a way that is consistent with them (behavioral statement 101); and to think and act independently, ask for advice and not be overly dependent on others to make decisions (behavioral statement 102).

Thus, the Align element variable 33 preferably comprises nine item variables 36 rating an individual's capacity to mobilize stakeholders 67, create teamwork and trust 71, relate to others interpersonally 75, communicate 79, work with cultural differences 83, create a shared need 87, be optimistic 91, manage stress 95, and be personally aligned and use intrapersonal skills 99 (FIGS. 5E-5M).

In addressing a leader's ability to take effective action, Act element variable 34 describes effort and an important law, the “80:20 law” which states that 80% of the effort produces only 20% of the benefit. Or, in other words, 20% of the effort produces 80% of the benefit. Identifying the 20% of the effort producing 80% of the benefit is crucial to effective management. It enables one to delegate or dispense with unimportant tasks which consume effort.

Certain tasks almost always constitute a leader's 20% effort. Such tasks include “self management,” “vision-to-market,” “holding big pictures,” “managing key relationships,” “organizational alignment,” “action learning,” and “key systems and resources,” as described hereinafter.

The “self management” task is the attention the leader pays to him or herself; ensuring he or she is personally in alignment, as described above; taking care to step back from the day-to-day and focus on high leverage activities; and taking care of his or her own emotional health and well being.

The from “vision-to-market” task means that articulating visions and formulating strategies are prerogatives of the leader, because it is quite difficult for a leader to decide what other tasks belong exclusively to him/her, until the leader has a pretty clear idea of where he/she is going.

“Holding big pictures” in mind of the external marketplace and of the organization as a ‘system’ within it is also a pre-requisite for developing anticipation skills. It is hard to decide, for example, what ‘weak signals’ are deserving of attention and the focus mental agility, unless the leader has clear objectives and at least a general idea of what his/her organization as a whole is now, or might become capable of.

Whether one calls it a vision, mission or strategy, an organization needs to know where it is going, and why, and it is the leader's responsibility to set that course and get that purpose “into the muscle” of the organization. Purposes are the products of possibilities and potentials. Leaders can spot the possibilities only if they understand the external system, and leaders will be able to help the organization realize its potential only if they understand the internal system and the nature of their influence within it.

The “managing key relationships” task means that among the most important agents in a leader's “internal system” are what might be called one's “upward stakeholders”—one's immediate superior(s), others both within and outside the organization who have direct authority over the leader and, in the case of CEOs and other senior executives, the board and shareholders. It is the leader's responsibility to manage their part of the organization's relationships with such powerful agents within whose gift lie the resources, freedoms and support needed to achieve a leader's goals.

The “organizational alignment” task is an important, and often neglected, leadership task. It is the mobilization of the organization to act in concert to deliver strategic goals. Aligned organizations learn, and behind every learning organization lie teacher-leaders. Teaching leads to empowerment, and when the leader teaches—when teacher becomes one of the roles the leader embodies a wave-front of empowerment can cascade down through the organization and supercharge its capabilities.

On-the-job coaching, or “action learning” involves a one-to-one, apprentice-master relationship. Learning contracts are personal trades. People are much more likely to do what is asked of them, to the best of their abilities, and in the spirit of the organization vision, if the leader helps them to become more capable. Leaders cannot coach everyone, but they can coach and develop their direct contacts, and in doing so, can establish traditions of coaching and mentoring for alignment throughout the organization.

The “key systems and resources” task means to identify and ensure that the organization has what it needs to succeed. It involves aligning systems—technical and social—to the leaders goals, and ensuring that resources are sufficiently flexible to respond quickly to changes in the environment.

Having found the 20%, time and resources should be allocated according to identified priorities. An effective leader has the ability to delegate tasks to free up his/her own resources for more productive outlets. In order to delegate effectively, leaders should possess the ability to get other people to do work he/she used to do and to cultivate their willingness and eagerness to take on a task. In vibrant, creative, empowered organizations responsibilities move down the hierarchy. People are generally keen to stretch themselves and face new challenges, and an effective leader will make them feel that taking on delegated tasks is part of their career development. Effective leaders will train and motivate people.

Effective leaders also appreciate the value of long term solutions over short-term quick fixes. Effective leaders have the ability to spell out long-term goals that make tolerable what would otherwise be seen as the pursuit of a series of apparently trivial, constantly changing subgoals. Leaders with the mental agility and patience needed to try different approaches when progress stalls, or make in-course corrections when circumstances dictate, can maintain an overall vision in their organizations.

Referring to FIGS. 5N-5S, Act element variable 34 preferably comprises six item variables 37 aimed at evaluating an individual's capacity to define tasks and direct ability 103, make decisions 107, act on decisions 111, adapt to changing circumstances 117, maintain desire and determination 121, and sustain exceptional performance 125. These qualities go to an individual's ability to prioritize tasks and focus on areas where the most value can be added; act quickly and rely on timely changes in direction, rather than searching for perfect solutions; and know when to stop and redirect time to other, more productive, pursuits.

Leaders should be able to define what to do and to direct ability. Preferably, this means the ability to identify and clearly communicate action steps to deliver an organization goal, directing teams and subordinates to act appropriately. Referring to FIG. 5N, an individual's ability to define what to do and direct ability 103 is desirably evaluated by rating the individual on a numerical scale of 1 to 4 based on behavioral statements evaluated during the interview. In the interview, preselected questions are asked of an individual to elicit responses indicative of the individual's ability to translate vision into meaningful strategy and actions (behavioral statement 104); to define clear outcomes, roles and responsibilities and communicate clear expectations to co-workers, subordinates and superiors (behavioral statement 105); and to seek out and build on innovative, leading edge solutions to drive the organization forward (behavioral statement 106).

Leaders should have the ability to make decisions, which is preferably the combination of reaching conclusions decisively and appropriately regarding courses of action or direction. Referring to FIG. 50, an individual's ability to make decisions 107 is desirably evaluated by rating the individual on a numerical scale of 1 to 4 based on behavioral statements evaluated during the interview. In the interview, preselected questions are asked of an individual to elicit responses indicative of the individual's ability to make timely decisions and take personal responsibility and accountability for them (behavioral statement 108); to make decisions that take into account a range of options, weigh the value of alternatives, select those most appropriate to achievement of goals (behavioral statement 109); and to encourage decisions to be taken by and with the involvement of the most appropriate levels (behavioral statement 110).

Leaders should be able to act on decisions, which is preferably both the ability to take an appropriate course of action in a timely manner and to ensure that other involved parties do likewise. Referring to FIG. 5P, an individual's ability to act on decisions 111 is desirably evaluated by rating the individual on a numerical scale of 1 to 4 based on behavioral statements evaluated during the interview. In the interview, preselected questions are asked of an individual to elicit responses indicative of the individual's ability to foster a real sense of urgency, be fast thinking and fast acting and encourage that amongst others without compromising the quality of outcomes, and not be hampered by analysis paralysis (behavioral statement 112); to relentlessly track and measure performance against goals and act to overcome obstacles (behavioral statement 113); and to manage and prioritize the competing pressures of tasks, people and resources to ensure things are done most effectively (80:20 management) (behavioral statement 114).

Leaders should be able to adapt well, adaptability preferably being the ability to appropriately change one's action and attitudes to reflect changing circumstances. Referring to FIG. 5Q, an individual's adaptability 117 is desirably evaluated by rating the individual on a numerical scale of 1 to 4 based on behavioral statements evaluated during the interview. In the interview, preselected questions are asked of an individual to elicit responses indicative of the individual's ability to demonstrate personal flexibility and be prepared to adapt to changing priorities (behavioral statement 118); to encourage the team to review the way in which it is working in order to improve effectiveness (behavioral statement 119); and to view setbacks, changes and mistakes as opportunities to learn and develop encouraging and supporting others to do the same (behavioral statement 120).

A leader should have desire and determination, preferably defined as those personal attributes that enable an individual to take a course of action energetically and to stick with it until results are delivered. Referring to FIG. 5R, an individual's desire and determination 121 is desirably evaluated by rating the individual on a numerical scale of 1 to 4 based on behavioral statements evaluated during an interview. In the interview, preselected questions are asked of an individual to elicit responses indicative of the individual's ability to be willing and tenacious in taking the lead (behavioral statement 122); to proactively identify blocks and barriers to success and work tirelessly to remove them (behavioral statement 123); and not to take “no” for an answer, but seek to find a solution that will work (behavioral statement 124).

A leader should be able to have sustained exceptional performance, preferably defined as the capacity to perform at higher than average levels consistently and over a long period of time. Referring to FIG. 5S, an individual's ability to have sustained exceptional performance 125 is desirably evaluated by rating the individual on a numerical scale of 1 to 4 based on behavioral statements evaluated during an interview. In the interview, preselected questions are asked of an individual to elicit responses indicative of the individual's ability to have a strong track record of outstanding performance and maintain motivation to achieve these high standards (behavioral statement 126); to set challenging, yet realistic performance targets for self and others and adopt strategies that sustain the motivation and performance of individuals, teams and the organization as a whole (behavioral statement 127); and to enthuse others to strive to continually exceed expectations and regularly review his/her own and others effectiveness to generate improvement and continued high performance (behavioral statement 128).

Thus, Act element 34 preferably comprises six item variables 37 evaluating an individual's capacity to define tasks and direct ability 103, make decisions 107, act on decisions 111, adapt to changing circumstances 117, maintain desire and determination 121, and sustain exceptional performance 125 which evaluate an individual's ability to prioritize tasks and focus on areas where the most value can be added; act quickly and rely on timely changes in direction, rather than searching for perfect solutions; and know when to stop and redirect time to other pursuits (FIGS. 5N-5S).

When assessing individuals in the context of post-merger integration projects, it is valuable to assess an individual's reaction to and opinion of the merger, and its implications both for the individual and for the organization. This information can then be used to identify champions who will be able to expedite post-merger integration of the two organizations; to identify and work with potential blockers of the merger program; to design and implement communication strategies and programs to build consensus around the merger and to mobilize support for the merger.

The following table illustrates a preferred set of interview criteria/questions to be taken into account when assessing individuals in a post-merger integration context:

Personal Situation:
What maintains your motivation?
What causes dissatisfaction for you?
What 3 things will keep you in the business?
What 3 things could cause you to leave?
Merger Experience:
What have been your experiences of mergers and acquisitions?
What have you learned from them?
What has been the single most significant blockage/issue in the mergers
you have experienced?
To what extent is that true of this merger?
What does this merger mean to you, to your team and to the organization?
What would you regard as the most important issue to focus upon?
What are your recommendations for how the merger should proceed?
What do you see to be the role of management in the merger process?
Culture:
How would you describe the culture in the business?
What is it like at its best/worst?
What are the norms and unwritten rules that pervade the business?
What is it that no one talks about, but underpins all that happens?
What are the challenges of merging the respective cultures?
What aspects of the respective cultures should prevail?
How can this be achieved?
What should we be most wary of with the current culture? What has
to change?
Integration:
How should the integration be approached?
What are the priorities for the first 30, 60 and 90 days?
What are the main blocks/barriers to achieving these?
What do the respective businesses bring to the merger?
How is the merger viewed by the respective businesses?
How can the positive be capitalized and the negatives minimized?
How equipped are the staff and management to handle the merger process?
What skills and experiences are missing ?
What needs to happen to ensure that key stakeholders feel involved in, and
committed to, making the merger a success?

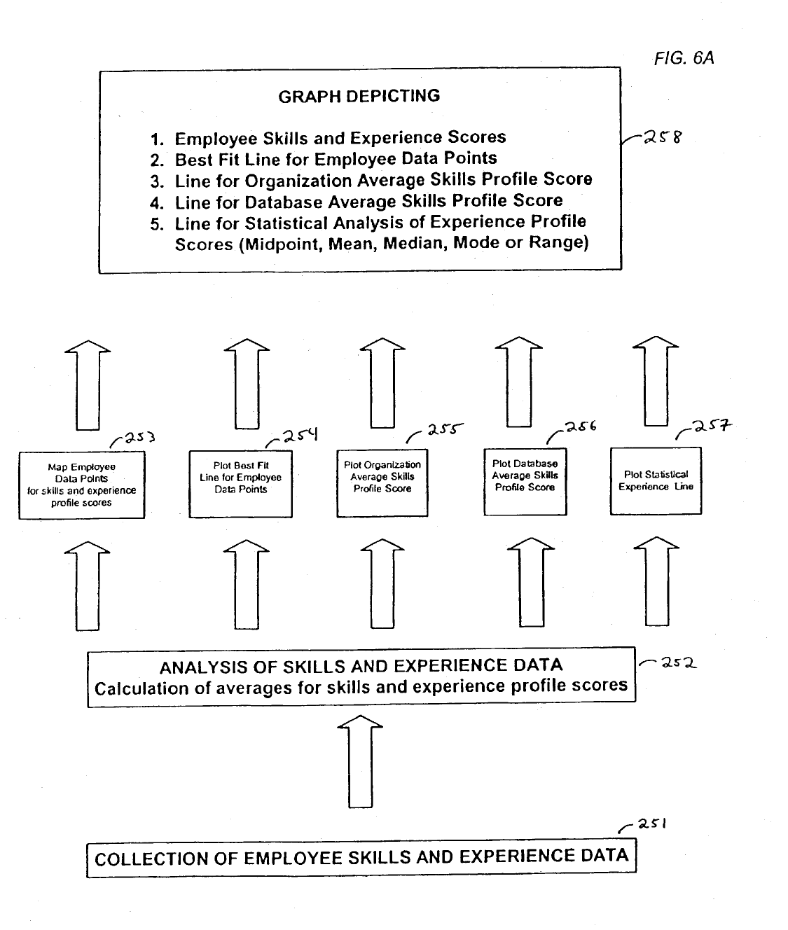

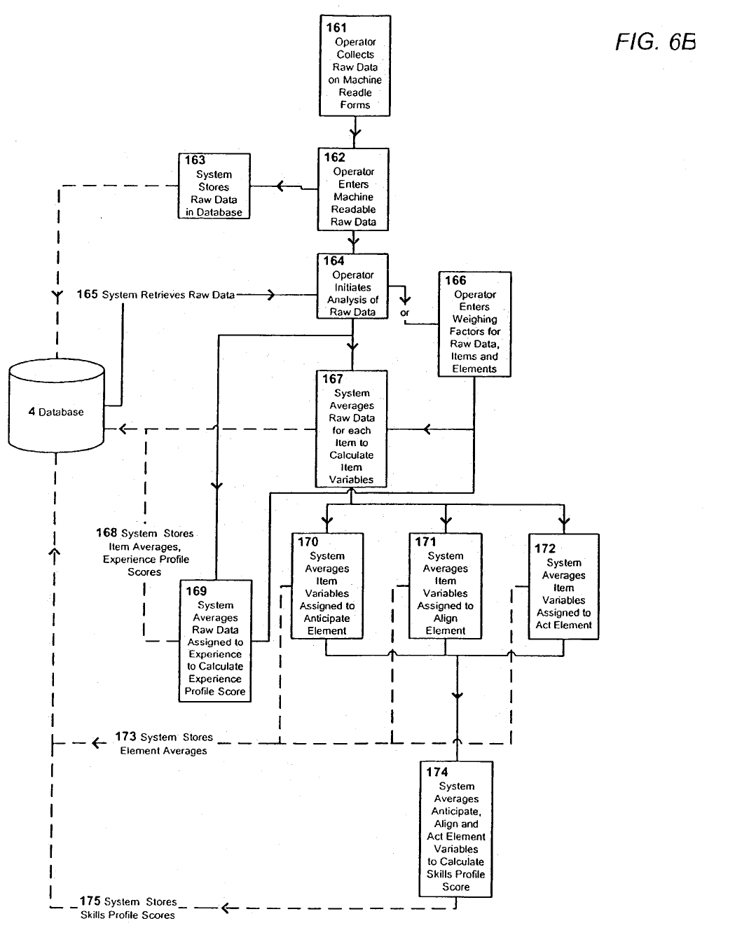

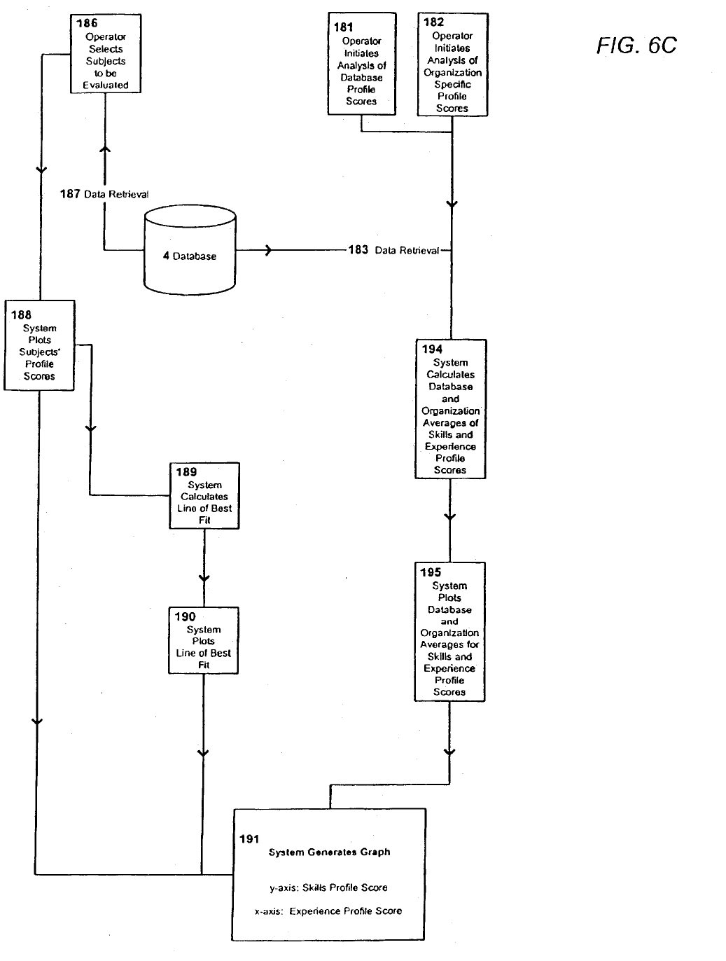

Referring now to FIG. 6A, the preferred method of assessing leadership capabilities of individuals involves the collection, analysis and comparison of skills and experience data. Raw management assessment data relating to skills and experience levels for each individual assessed are collected and input (step 251). The input data are then used to calculate the skills profile score for each individual assessed and the experience profile score for each individual assessed (step 252). Preferably, data points are then mapped for each individual based on their skills and experience profile scores (step 253). The mapped data points are then used to calculate a best fit line (step 254). After mapping the data points, a best fit line is plotted on a graph for the data points. Averages of skills profile scores for the organization and skills profile scores for the database are then plotted as lines on the graph (steps 255-256). A line representing an average of experience profile scores for the organization is then plotted on the graph (step 257). A graph depicting the lines and data points plotted in steps 253-257 above is then generated (step 258).

Referring now to FIG. 6B, the raw management assessment data are preferably collected by scoring each individual's behavioral and personality traits and their experience data on machine readable forms (step 161). Desirably, behavioral and personality traits are assessed via the interview process as described above in connection with FIGS. 5A-5S. Experience data are preferably scored by measuring an individual's time spent in their role or position, in the organization and in the industry in units of time, such as, but not limited to days, weeks, months or years.

The collected raw management assessment data are then input into system 20 preferably using equipment capable of reading paper forms (step 162). It should be understood that raw management assessment data can be input manually via computer input devices such as, but not limited to, a mouse and keyboard. System 20 then electronically transmits and stores the raw management assessment data to database 4 (step 163).

An analysis of the raw management assessment data can then be initiated, preferably by clicking a mouse or other pointing device on a graphically represented button (step 164). When analysis is initiated, system 20 electronically retrieves the stored raw management assessment data from database 4 (step 165). After the retrieval of data, system 20 prompts entry of weighing factors preferably via a customized graphical user interface displayed on conventional display device 10 shown in FIG. 1 (step 166). Weighing factors are preferably entered in the form of keyboard typed text in specially designated fields. It should be understood that varying or equal weights may be assigned to each of the raw management assessment data/behavioral statement, item, and element variables. It should also be understood that a user of system 20 can opt to not enter any weighing factors, resulting in the calculation of unweighted averages.

System 20 then uses raw management assessment data relevant to the Anticipate, Align, and Act element variables (32, 33, 34) to electronically calculate weighted or unweighted averages for item variables (35, 36, 37) corresponding to the Anticipate, Align and Act, element variables (32, 33, 34) (step 167). As described above in connection with FIGS. 5A-5S, item variables are preferably groupings of behavioral statements relating to personality and behavioral traits. Desirably, each item variable comprises one or more behavioral statements which are scored on a numeric scale.

System 20 then averages raw management assessment data relevant to experience to electronically calculate a weighted or unweighted experience profile score (step 168). Item variables calculated in step 167 and the experience profile score calculated in step 168 can be electronically transmitted to and stored in database 4 (step 169).

A weighted or unweighted average for the Anticipate element variable 32 is then calculated from item variables relevant to the Anticipate element variable (step 170). A weighted or unweighted average for the Align element variable 33 is calculated from item variables relevant to the Align element variable (step 171). A weighted or unweighted average for the Act element variable 34 is calculated from item variables relevant to the Act element variable (step 172).

The Anticipate, Align and Act element variables (32, 33, 34) calculated in steps 170-172 (step 173) are then preferably electronically transmitted to and stored in database 4. The Anticipate, Align and Act element variables are then averaged to yield a weighted or unweighted average representing a skills profile score (step 174) which can be electronically transmitted to and stored in database 4 (step 175).

The step-wise algorithmic format, depicted in FIG. 6B, of this process is conducive to programming a computer to calculate and display results as it breaks down the averaging of large numbers of variables into a series of smaller operations.

The user of system 20 preferably inputs machine readable raw management assessment data, in the form of paper data sheets, into scanner reader 7 connected to user interface 2 depicted in FIG. 1.

It should be understood that varying or equal weights may be assigned to each of the raw management assessment data/behavioral statement, item, and element variables. It should also be understood that raw management assessment data/experience data/behavioral statement variables, item variables and element variables may be reduced or increased in number.

Additionally, it should be understood that the above-described process can be carried out by alternative systems capable of performing the steps of the inventive method described herein. While it is preferred that the raw management assessment data, calculated variables and profile scores be transmitted to and stored in a database, they can be transmitted to and stored via other computer storage formats such as but not limited to a spreadsheet or the like.

Referring now to FIG. 6C, a comparison of an individual's management assessment skills to database and organization averages, and to other individuals, is preferably carried out by initiating an analysis of database profile scores (step 181) and organization specific profile scores (step 182), preferably by clicking a mouse or other pointing device on graphically represented buttons for database analysis and organization analysis. Desirably, the organization analysis button depicts the name or logo of the organization whose personnel are being assessed.

System 20 then retrieves skills and experience profile scores from database 4 (step 183) and calculates an average for all skills profile scores stored in database 4, an average for all skills profile scores specific to the evaluated organization stored in database 4, and an average for all experience profile scores stored in database 4 (step 184). Preferably, system 20 then plots lines representing the averages calculated in step 184 by plotting a line for the average of all skills profile scores stored in database 4, by plotting a line for the average of all skills profile scores specific to the evaluated organization stored in database 4, and by plotting a line for the average of all experience profile scores stored in database 4 (step 185).

Desirably, individuals to be evaluated are selected at step 186. Selection of individuals is preferably accomplished by mouse controlled selection from a menu of organization personnel listed by name. The menu can also list departments within the organization and preferably offers the option to select all personnel. System 20 then retrieves the individuals' skills and experience profile scores from database 4 (step 187).

Then, data points for each individual to be assessed are plotted by placing a data point at the intersection of the individual's skills profile score on a y-axis and experience profile score on an x-axis (step 188). After data points have been plotted, system 20 calculates a best fit line for individuals' data points (step 189) and then plots the best fit line calculated in step 189 (step 190). System 20 then preferably displays a graph showing each individual data point and the lines plotted in steps 185, 188 and 189 (step 191).

The user of system 20 desirably has the option to produce a paper print-out of the preferred graph generated in step 191 via a printer, as described above, or to produce an electronically stored copy of the graph of step 191 via a computer storage device, as described in FIG. 1.

It should be understood that the above described process may be carried out by alternative systems capable of performing the steps of the method described herein. It should also be understood that while it is preferred that the raw management assessment data, calculated variables and profile scores be retrieved from a database, they may be retrieved from other computer storage formats such as but not limited to a spreadsheet or the like. It should be further understood that the process described above may output data in formats other than graphs that easily allow comparison of individuals to be made such as but not limited to tables, charts and the like.

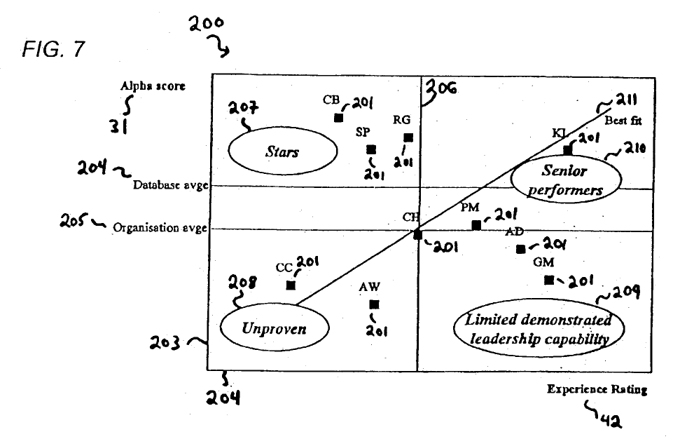

FIG. 7 depicts a representative graphical output from the above described preferred system 20 effecting the inventive method, generally indicated as reference number 200, which includes a y-axis 203 depicting skills profile score 31, an x-axis 202 depicting experience profile score 42, a line 204 depicting a database average of skills profile scores, a line 205 depicting an organization average of skills profile scores, a line 206 depicting an organization average of experience profile scores, a best fit line 211 for an individual's data points, a “stars” quadrant 207, an “unproven” quadrant 208, a “limited demonstrated leadership capability” quadrant 209, a “senior performmers” quadrant 210, and an individual data point 201 marking an individual's combination of skills profile score and experience profile score.

As described more fully above, skills profile score 31 represents an individual's leadership and/or management skills, while experience profile score 42 represents the amount of time an individual has spent in a particular position, industry and organization.

Line 204 depicts a database average of skills profile scores for all individuals included in database 4. Line 204 thus allows a user to compare the skills profile scores of multiple individuals against an average skills profile score calculated from a large pool of individuals. Because the number of individuals in the pool can be large, a statistically significant comparison of multiple individuals to an expected average can be achieved

Line 205 depicts an organization average of skills profile scores for all individuals identified with a particular organization in database 4. Line 205 thus allows the skills profile scores of multiple individuals to be compared against an average skills profile score calculated from a pool of individuals endemic to the organization. Because the pool of individuals is from within the organization, a comparison of multiple individuals to an expected average for a particular organization can be achieved. It should be understood that other subsets of data can likewise be used to compare individuals based on criteria other than membership in a particular organization.

Line 206 depicts an organization average of experience profile scores in database 4. Line 206 thus allows the experience profile scores of multiple individuals to be compared against an average experience profile score calculated from a pool of individuals endemic to the organization. Because the pool of individuals is from within the organization, a comparison of multiple individuals to an expected average for a particular organization can be achieved. It should be understood that a database average of experience profile scores can likewise be used to compare individuals. It should also be understood that other subsets of data can likewise be used to compare individuals based on criteria other than membership in a particular organization.

Line 211 depicts a best fit line for individual data points. By mapping the best fit line the average progress in skills and experience can be tracked. For example, a shallow sloped best fit line would indicate a low level of skills development for the assessed individuals as experience increases, indicating a need to develop stronger management skills within the organization. While a steep sloped best fit line would indicate a high level of skills development for the individuals as experience increases, indicating a need for example, to review the organization to ensure that highly skilled personnel are not underutilized. It should be understood that multiple conclusions may be drawn from the slope of the best fit line depending on the particular circumstances of the organization.

Graph 200 is preferably divided into four quadrants bounded by line 205 and line 206. As mentioned above and described more fully below, the four quadrants represent rating areas for combinations of skills and experience profile scores. It should be understood that the graph may be divided into quadrants by other combinations of lines representing averages of preselected profile scores.

The “stars” quadrant 207 represents developing leaders, the quadrant of graph 200 where individuals have high management skill levels, but lack experience. Identification of stars is a valuable input to succession management and the retention of high potential individuals. Individuals falling within this quadrant are likely to develop into leaders as their experience increases over time. Individuals falling in the stars quadrant may be candidates for increased responsibility and experience development.

The “unproven” quadrant 208 represents unproven leaders, the quadrant of graph 200 where individuals have low management skill levels, and lack experience. Individuals within this quadrant need to increase their management skills as they progress in their particular role. Individuals falling within the unproven rating area may be candidates for increased training and development of management skills. Unproven individuals can receive the appropriate coaching and training to build their skills early in their career.

The “limited demonstrated leadership capability” quadrant 209 represents poor leaders, the quadrant of graph 200 where individuals have low management skill levels, but have high experience. Individuals falling within this quadrant may be candidates for outplacement or relocation.

The “senior performers” quadrant 210 represents strong leaders, the quadrant of graph 200 where individuals have high management skill levels and high experience. Individuals falling within this quadrant represent proven leaders who should be candidates for promotion and/or retention.

It should be appreciated that an individual's location within a given quadrant also provides an indication of the relative level of such individual's skills and experience within the given quadrant.

Data point 201 is a graphical representation of an individual's skills profile score plotted over their experience profile score. By placing each individual at a defined location on graph 200, each individual can be compared individually with respect to the above described lines 204, 205, 206 and 211 as well as to the above described quadrants 207, 208, 209, and 210.

In accordance with the foregoing, the present invention provides a new method and system for enabling an organization to obtain information concerning the leadership skills of its personnel or candidate personnel in a format, preferably graphical, that allows comparison of an individual's leadership skills against the average leadership skills of the organization and/or the average leadership skills across a particular industry or other grouping of individuals. The leadership characteristics assessed by the method and system of the present invention desirably include skills in the above described Anticipate, Align and Act elements and experience data relating to an individual's tenure as described above.

The present invention further provides a method and system which groups assessed personnel or candidate personnel into four readily identifiable, preferably graphically displayed, groups based on permutations of skills and experience. Also, the method and system of the present invention provides a best fit line for all of an entity's assessed personnel. Thus, a user of the method and system of the present invention can readily determine the relative leadership competencies of their personnel and candidate personnel, can determine the rate of increase in skills over time, and formulate effective strategies to maximize and improve personnel resources as is more fully described above.

The embodiment that is presently disclosed is intended to serve as an illustrative example of the present invention, it will be appreciated that the present invention is not limited to those precise embodiments, and that various changes and modifications can be effected therein by one of ordinary skill in the art without departing from the scope and spirit of the invention as defined herein.

It is also to be understood that the following claims are intended to cover all of the generic and specific features of the invention herein described and all statements of the scope of the invention which, as a matter of language, might be said to fall therebetween.

In so far as embodiments of the invention described herein can be implemented, at least in part, using software controlled programmable processing devices, such as a computer system, it will be appreciated that one or more computer programs for configuring such programmable devices or system of devices to implement the foregoing described methods are to be considered an aspect of the present invention. The computer programs can be embodied as source code and undergo compilation for implementation on processing devices or a system of devices, or can be embodied as object code, for example. Those of ordinary skill will readily understand that the term computer in its most general sense encompasses programmable devices such as those referred to above, and data processing apparatus, computer systems and the like.

Preferably, the computer programs are stored on carrier media in machine or device readable form, for example in solid-state memory or magnetic memory such as disk or tape, and processing devices utilize the programs or parts thereof to configure themselves for operation. The computer programs can be supplied from remote sources embodied in communications media, such as electronic signals, radio frequency carrier waves, optical carrier waves and the like. Such carrier media are also contemplated as aspects of the present invention.

It will thus be seen that the objects set forth above, among those made apparent from the preceding description, are efficiently attained and, since certain changes can be made in carrying out the above method and in the constructions set forth for the system without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A method for assessing leadership qualities of individuals, comprising the steps of:
inputting first data representing experience of at least one individual,
inputting second data representing at least one of behavioral and personality traits of the at least one individual,
statistically reducing the first data input to a first score,
statistically reducing the second data input to a second score,
providing benchmark data representing at least one of first scores and second scores for a preselected set of individuals,
comparing the first and second scores against the benchmark data, and
categorizing the at least one individual based on the comparison of the first and second scores against the benchmark data to generate an assessment of the at least one individual's leadership qualities.

2. The method according to claim 1, wherein the first data and the second data are evaluated during an interview of the at least one individual.

3. The method according to claim 1, wherein the first data includes the at least one individual's tenure in at least one of role, organization and industry.

4. The method according to claim 1, wherein the second data includes the at least one individual's skill level in at least one of an ability to anticipate, an ability to be aligned, and an ability to act.

5. The method according to claim 4, wherein the ability to anticipate includes at least one of initiative, weak signal detection, vision, clarity of purpose, natural curiosity, mental agility, judgment, and problem solving skills.

6. The method according to claim 4, wherein the ability to be aligned includes at least one of a capacity to mobilize stakeholders, to create teamwork and trust, to effectively use interpersonal skills, to communicate effectively, to work with cultural differences, to create a shared need, to be optimistic, to manage stress, to be personally aligned and to effectively use intrapersonal skills.

7. The method according to claim 4, wherein the ability to act includes at least one of a capacity to define tasks and direct ability, to make decisions, to implement decisions, to adapt to changing circumstances, to maintain desire and determination, and to sustain exceptional performance.

8. The method according to claim 1, wherein the step of statistically reducing the first data input to the first score includes calculating an average of the first data input.

9. The method according to claim 8, wherein the calculated average of the first data input is a selectively weighted average.

10. The method according to claim 1, wherein the step of statistically reducing the second data input to the second score includes calculating an average of the second data input.

11. The method according to claim 10, wherein the calculated average of the second data input is a selectively weighted average.

12. The method according to claim 1, wherein the step of providing benchmark data representing at least one of the first scores and second scores for a preselected set of individuals includes calculating an average of the first scores for the preselected set of individuals.

13. The method according to claim 1, wherein the step of providing benchmark data representing at least one of the first scores and second scores for a preselected set of individuals includes calculating an average for the second scores for the preselected set of individuals.

14. The method according to claim 1, wherein the step of providing benchmark data representing at least one of first scores and second scores for a preselected set of individuals includes calculating an average of the first scores for a preselected subset of the preselected set of individuals.

15. The method according to claim 1, wherein the step of providing benchmark data representing at least one of first scores and second scores for a preselected set of individuals includes calculating an average of the second scores for a preselected subset of the preselected set of individuals.

16. The method according to claim 1, wherein the step of providing benchmark data representing at least one of first scores and second scores for a preselected set of individuals includes calculating a function representing average progress of individuals for the preselected set of individuals.

17. The method of claim 1, wherein the step of categorizing the at least one individual includes classifying the at least one individual as one of developing leader, strong leader, unproven leader and poor leader based on the first and second scores of the at least one individual relative to the benchmark data.

18. The method of claim 1, further comprising the step of recommending a course of action based on the assessment of the at least one individual's leadership qualities.

19. A method for assessing leadership qualities of individuals, comprising the steps of:
inputting first data representing experience of at least one individual,
inputting second data representing at least one of behavioral and personality traits of the at least one individual,
statistically reducing the first data input to a first score,
statistically reducing the second data input to a second score,
graphically representing the first and second scores for the at least one individual,
providing benchmark data representing at least one of first scores and second scores for a preselected set of individuals,
graphically representing the benchmark data,
comparing the first and second scores against the benchmark data,
graphically categorizing the at least one individual based on the comparison of the first and second scores against the benchmark data to determine the at least one individual's leadership qualities, and
generating a report in graphical format of the at least one individual's leadership qualities.

20. The method according to claim 19, wherein the first data and the second data are evaluated during an interview of the at least one individual.

21. The method according to claim 19, wherein the first data includes the at least one individual's tenure in at least one of role, organization and industry.

22. The method according to claim 19, wherein the second data includes the at least one individual's skill level in at least one of an ability to anticipate, an ability to be aligned, and an ability to act.

23. The method according to claim 22, wherein the ability to anticipate includes at least one of initiative, weak signal detection, vision, clarity of purpose, natural curiosity, mental agility, judgment, and problem solving skills.

24. The method according to claim 22, wherein the ability to be aligned includes at least one of a capacity to mobilize stakeholders, to create teamwork and trust, to effectively use interpersonal skills, to communicate effectively, to work with cultural differences, to create a shared need, to be optimistic, to manage stress, to be personally aligned and to effectively use intrapersonal skills.

25. The method according to claim 22, wherein the ability to act includes at least one of a capacity to define tasks and direct ability, to make decisions, to implement decisions, to adapt to changing circumstances, to maintain desire and determination, and to sustain exceptional performance.

26. The method according to claim 19, wherein the step of statistically reducing the first data input to the first score includes calculating an average of the first data input.

27. The method according to claim 26, wherein the calculated average of the first data input is a selectively weighted average.

28. The method according to claim 19, wherein the step of statistically reducing the second data input to the second score includes calculating an average of the second data input.

29. The method according to claim 28, wherein the calculated average of the second data input is a selectively weighted average.

30. The method according to claim 19, wherein the step of providing benchmark data representing at least one of the first scores and second scores for a preselected set of individuals includes calculating an average of the first scores for the preselected set of individuals.

31. The method according to claim 19, wherein the step of providing benchmark data representing at least one of the first scores and second scores for a preselected set of individuals includes calculating an average for the second scores for the preselected set of individuals.

32. The method according to claim 19, wherein the step of providing benchmark data representing at least one of first scores and second scores for a preselected set of individuals includes calculating an average of the first scores for a preselected subset of the preselected set of individuals.

33. The method according to claim 19, wherein the step of providing benchmark data representing at least one of first scores and second scores for a preselected set of individuals includes calculating an average of the second scores for a preselected subset of the preselected set of individuals.

34. The method according to claim 19, wherein the step of providing benchmark data representing at least one of first scores and second scores for a preselected set of individuals includes calculating a function representing average progress of individuals for the preselected set of individuals, and graphically representing the calculated function as a best fit line.

35. The method of claim 19, wherein the steps of categorizing the at least one individual includes classifying the at least one individual as one of developing leader, strong leader, unproven leader and poor leader based on the first and second scores of the at least one individual relative to the benchmark data.

36. The method of claim 19, further comprising the step of recommending a course of action based on the assessments of the at least one individual's leadership qualities.

37. The method of claim 19, wherein the first and second scores of the at least one individual are graphically represented as data points on a graph.

38. The method of claim 19, wherein the benchmark data are represented as lines on a graph.

39. The method of claim 38, wherein the lines define boundaries on a graph for categorizing the at least one individual as one of developing leader, strong leader, unproven leader and poor leader based on the first and second scores of the at least one individual relative to the benchmark data.

40. A system for assessing leadership qualities of individuals, comprising:
means for inputting first data representing experience of at least one individual and second data representing at least one of behavioral and personality traits of the at least one individual,
means for statistically reducing the first data input to a first score and the second data input to a second score,
means for providing benchmark data representing at least one of first scores and second scores for a preselected set of individuals,
means for comparing the first and second scores against the benchmark data,
means for categorizing the at least one individual based on the comparison of the first and second scores against the benchmark data, and
means for generating an assessment of the at least one individual's leadership qualities.

41. The system of claim 40, wherein the means for generating an assessment is arranged and constructed to generate the assessment in graphical format.
